(19) United States
(12) Patent Application Publication
(10) Pub. No.: US 2011/0130113 A1
(43) Pub. Date: Jun. 2, 2011

(54) COMMUNICATION DEVICE

(76) Inventor: Shinji Takuno, Tottori (JP)

(21) Appl. No.: 13/055,055

(22) PCT Filed: Jun. 24, 2009
(86) PCT No.: PCT/JP2009/061517

§ 371 Date: Jan. 20, 2011

(30) Foreign Application Priority Data
Jul. 23, 2008 (JP) 2008-189650
Jul. 30, 2008 (JP) 2008-196327
Aug. 5, 2008 (JP) 2008-201505

(51) Int. Cl. H04M 11/04

(52) U.S. Cl. 455/404.1

(57) ABSTRACT

A communication device of the present invention includes: a communication section; an earthquake information calculation section for receiving an earthquake early warning by using the communication section; a control section for forcibly disconnecting a telephone line if the earthquake early warning has been received while the telephone line is connected; and a disconnection reason notification section for transmitting, if the telephone line has been forcibly disconnected due to the reception of the earthquake early warning, disconnection reason information, which indicates a disconnection reason, to a communication counterpart previously participating in a phone call with the communication device. The disconnection reason notification section refers to association information in which telephone numbers and e-mail addresses are associated with each other and thereby obtains an e-mail address associated with a telephone number for which the forcible disconnection has been performed. The disconnection reason notification section generates and transmits an e-mail that contains the disconnection reason to the obtained e-mail address.

### TECHNICAL FIELD

The present invention relates to a communication device, connected to a wide area communication network, for performing communication. The present invention particularly relates to a communication device for receiving an earthquake early warning distributed by a meteorological agency and providing evacuation instructions.

### BACKGROUND ART

The development of communication infrastructure in recent years has made various supplementary services widespread in the field of communication. For example, in the case of telephone devices, those capable of connecting not only to general telephone lines but also to wide area communication networks such as an IP telephone network and the Internet to receive various services such as a data communication service, are widely used.

One of the functions of such a communication device is a function of receiving an earthquake early warning that is distributed by a meteorological agency when an earthquake has occurred. In Japan, an information distribution service that provides earthquake early warnings has started on Oct. 1, 2007. This service is available to its users who have purchased a communication device capable of receiving earthquake early warnings and signed up with a company that provides an earthquake early warning distribution service.

Upon receiving an earthquake early warning at the occurrence of an earthquake, the communication device uses regional information which is stored in the communication device in advance, for example, latitude/longitude information about a location where the communication device is installed, thereby calculating an estimated seismic intensity, an expected arrival time of the principal shock (=part of the earthquake motion that is felt by the human body as the strongest shock, normally the S-wave), and the like.

The user is notified of the results of such calculation through, for example, an image displayed on a liquid crystal panel or a sound output from a loudspeaker. This allows the user to take evacuation actions before the principal shock arrives from the epicenter, for example, take cover under a table, put out flames, etc.

Patent Literature 1 discloses an in-house telephone system which is capable of receiving such an earthquake early warning as mentioned above. The in-house telephone system has functions of providing, by sound, pre-earthquake information or the like to the user and guiding the user to an evacuation route, without using a dedicated earthquake information display or the like.

Patent Literature 1: Japanese Laid-Open Patent Publication No. 2008-42320

### DISCLOSURE OF THE INVENTION

### Problems to be Solved by the Invention

According to Patent Literature 1, receiving an earthquake early warning makes it possible, for example, to prevent secondary disaster and to call for attention or allow a vehicle to stop before the principal shock arrives. Moreover, receiving an earthquake early warning makes it possible to give evacuation instructions based on, for example, an estimated seismic intensity and an expected arrival time of the earthquake.

However, if an earthquake early warning receiving function and a voice call function are realized by a single communication device or a single communication system as in the above case, announcing an earthquake early warning is prioritized when the earthquake early warning is received. For this reason, a telephone line is forcibly disconnected, or part of the functionality is made unavailable. Therefore, if an earthquake early warning is received during a phone call and a telephone line is disconnected accordingly, the other party cannot know what has caused the disconnection.

In such a situation, it is likely that the other party attempts to establish a connection again. However, since the communication device having received the earthquake early warning ceases a phone call function, such a reconnection request is not received, which makes the other party confused. In a case where the importance of information contained in the earthquake early warning is low, for example, a case where an estimated seismic intensity is so low as to be measured 1 on a seismic intensity scale, the telephone line is still forcibly disconnected even though the importance of the information is low. This makes the user feel inconvenienced.

The present invention has been devised to solve the above problems. An object of the present invention is to provide a communication device that does not immediately perform forcible disconnection of a telephone line upon receiving an earthquake early warning in a case where a predetermined condition is satisfied, and that is capable of notifying, after the telephone line is forcibly disconnected, the other party of a reason for the disconnection or a reason for incoming call rejection, and that can be used in a normal manner in a case where the importance of information contained in the earthquake early warning is low, without performing forcible disconnection of a telephone line, ceasing of its functions, and the like.

### Solution to the Problems

A communication device of the present invention includes: a communication section operable to connect to a communication network; an earthquake information calculation section for receiving an earthquake early warning from the communication network by means of the communication section to calculate earthquake information; a disconnection processing section for disconnecting a telephone line if the earthquake early warning has been received while the telephone line is connected by means of the communication section; and a disconnection reason notification section for transmitting disconnection reason information, which indicates a disconnection reason, to a communication counterpart on the telephone line that has been disconnected when the earthquake early warning has been received.

According to this configuration, the communication device of the present invention includes the communication section, which includes a network card, a wireless LAN device, and the like and which is operable to connect to a communication network. The communication device also includes the earthquake information calculation section for receiving an earthquake early warning from a wide area communication network such as the Internet by means of the communication section, which earthquake early warning is distributed by a meteorological agency, and for calculating earthquake information which includes an estimated seismic intensity and an expected arrival time of the principal shock. Moreover, the communication device includes the disconnection processing section for forcibly disconnecting a telephone line if the earthquake early warning has been received while the telephone line is connected. Furthermore, the communication device includes the disconnection reason notification section for transmitting, if the telephone line has been forcibly disconnected due to the reception of the earthquake early warning, disconnection reason information, which indicates a disconnection reason, to a communication counterpart previously participating in a phone call with the communication device.

Further, the communication device according to the present invention includes: a mail transmission section for transmitting an e-mail by means of the communication section; and a storage section for storing association information in which a telephone number and an e-mail address are associated with each other. The disconnection reason notification section determines, based on the association information, an e-mail address that is associated with a telephone number of the communication counterpart, and controls the mail transmission section to transmit an e-mail that contains the disconnection reason information to the determined e-mail address.

According to this configuration, the communication device of the present invention includes the mail transmission section for transmitting an e-mail. The communication device also includes the storage section for storing association information in which a telephone number and an e-mail address are associated with each other and which is, for example, an address book. If the telephone line has been forcibly disconnected due to the reception of the earthquake early warning, the disconnection reason notification section obtains, from the association information, an e-mail address that is associated with the telephone number of the communication counterpart previously participating in the phone call. Then, an e-mail containing a disconnection reason is created and transmitted to the obtained e-mail address.

Still further, the communication device of the present invention includes a number determination section for determining based on numbers contained in the telephone number whether or not the telephone number is a mobile phone number. If the number determination section has determined that the telephone number of the communication counterpart is a mobile phone number, the disconnection reason notification section determines, based on the association information, the e-mail address that is associated with the telephone number of the communication counterpart, and controls the mail transmission section to transmit an e-mail that contains the disconnection reason information to the determined e-mail address.

According to this configuration, the communication device of the present invention includes the number determination section for determining whether or not the telephone number is a mobile phone number. If the telephone line has been forcibly disconnected due to the reception of the earthquake early warning, the disconnection reason notification section determines by means of the number determination section whether or not the telephone number of the communication counterpart previously participating in the phone call is a mobile phone number. Then, only when the telephone number is determined to be a mobile phone number, an e-mail that contains a disconnection reason is transmitted to an e-mail address that is associated with the telephone number of the communication counterpart previously participating in the phone call.

Still further, in the communication device of the present invention, the disconnection reason notification section determines based on the association information whether or not the e-mail address that is associated with the telephone number of the communication counterpart is a mobile phone e-mail address, and if determining that the e-mail address is a mobile phone e-mail address, controls the mail transmission section to transmit an e-mail that contains the disconnection reason information to the e-mail address.

According to this configuration, only when the e-mail address associated with the telephone number of the communication counterpart previously participating in the phone call is contained in the association information as a mobile phone e-mail address, the disconnection reason notification section transmits an e-mail that contains a disconnection reason to the e-mail address.

Still further, the communication device of the present invention includes a rejection reason notification section for rejecting, if the communication section detects a request for connection of a telephone line within a predetermined period after the earthquake information calculation section has received the earthquake early warning, the request for the connection, and for transmitting rejection reason information, which indicates a rejection reason, to the source of the request for the connection.

According to this configuration, the communication device of the present invention includes the rejection reason notification section for rejecting, when the communication section detects a request for connection of a telephone line within a predetermined period after the earthquake information calculation section has received the earthquake early warning, the request for the connection, that is, performing incoming call rejection, and for transmitting rejection reason information, which indicates a reason for the incoming call rejection, to the source of the request for the connection.

Still further, the communication device of the present invention includes: a mail transmission section for transmitting an e-mail by means of the communication section; and a storage section for storing association information in which a telephone number and an e-mail address are associated with each other. The rejection reason notification section determines, based on the association information, an e-mail address that is associated with a telephone number of the source, and controls the mail transmission section to transmit an e-mail that contains the rejection reason information to the determined e-mail address.

According to this configuration, the communication device of the present invention includes the mail transmission section for transmitting an e-mail. The communication device also includes the storage section for storing association information in which a telephone number and an e-mail address are associated with each other and which is, for example, an address book. When the communication section detects a request for connection of a telephone line within a predetermined period after the earthquake information calculation section has received the earthquake early warning, the rejection reason notification section obtains, from the association information, an e-mail address that is associated with the telephone number of the source of the request. Then, an e-mail containing a reason for incoming call rejection is created and transmitted to the obtained e-mail address.

Still further, the communication device of the present invention includes a number determination section for determining based on numbers contained in the telephone number whether or not the telephone number is a mobile phone number. If the number determination section has determined that the telephone number of the source is a mobile phone number, the rejection reason notification section determines, based on the association information, the e-mail address that is associated with the telephone number of the source, and controls the mail transmission section to transmit an e-mail that contains the rejection reason information to the determined e-mail address.

According to this configuration, the communication device of the present invention includes the number determination section for determining whether or not the telephone number is a mobile phone number. When a request for connection of a telephone line is detected within a predetermined period after the reception of the earthquake early warning, the rejection reason notification section determines by means of the number determination section whether or not the telephone number of the source of the request for the connection is a mobile phone number. Only when the telephone number is determined to be a mobile phone number, an e-mail containing a reason for incoming call rejection is transmitted to an e-mail address that is associated with the telephone number of the source.

Still further, in the communication device of the present invention, the rejection reason notification section determines based on the association information whether or not the e-mail address that is associated with the telephone number of the source is a mobile phone e-mail address, and if determining that the e-mail address is a mobile phone e-mail address, controls the mail transmission section to transmit an e-mail that contains the rejection reason information to the e-mail address.

According to this configuration, only when the e-mail address associated with the telephone number of the source of the request for the connection is contained in the association information as a mobile phone e-mail address, the rejection reason notification section transmits an e-mail that contains a reason for incoming call rejection to the e-mail address.

Still further, the communication device of the present invention includes: a timer section for keeping time; a sound processing section for performing a process of decoding sound information; a loudspeaker for outputting a sound; and a period determination section for calculating, if the earthquake early warning has been received while the telephone line is connected by means of the communication section, an estimated period before arrival of an earthquake by means of the earthquake information calculation section and the timer section, and for determining whether or not the estimated period exceeds a predetermined threshold. When the period determination section determines that the estimated period exceeds the threshold, the disconnection processing section performs the following: instruct the sound processing section to generate a notification sound notifying that the earthquake early warning has been received or that the telephone line is to be disconnected; transmit the generated notification sound to the telephone line by means of the communication section and output the generated notification sound by means of the loudspeaker; and control the communication section to disconnect the telephone line.

According to this configuration, the communication device of the present invention includes the timer section for keeping the current time, the sound processing section for performing a process of decoding sound information, and the loudspeaker for outputting a sound. The communication device also includes the period determination section for calculating, if the earthquake early warning has been received while the telephone line is connected by means of the communication section, an estimated period which exists before the arrival of the earthquake (=a preparation period in which evacuation actions can be taken) by means of the earthquake information calculation section and the timer section, and for determining whether or not the estimated period exceeds a predetermined threshold. The communication device further includes the disconnection processing section for instructing, when the period determination section has determined that the estimated period exceeds the predetermined threshold, the sound processing section to generate a notification sound notifying that the earthquake early warning has been received or that the telephone line is to be disconnected. Upon receiving the instruction, the sound processing section outputs the generated sound from the loudspeaker, and transmits the generated sound to the telephone line by means of the communication section. This allows the other party to recognize the notification sound. After the above processing has been completed, the disconnection processing section disconnects the telephone line, and then a normal earthquake early warning announcement process is performed.

Still further, the communication device of the present invention includes a seismic intensity determination section for determining, if the earthquake early warning has been received while the telephone line is connected by means of the communication section, whether or not an estimated seismic intensity contained in the earthquake information calculated by the earthquake information calculation section exceeds a predetermined threshold. When the seismic intensity determination section has determined that the estimated seismic intensity is less than the threshold, the disconnection processing section performs the following: instruct the sound processing section to generate a notification sound notifying that the earthquake early warning has been received or that the telephone line is to be disconnected; transmit the generated notification sound to the telephone line by means of the communication section and output the generated notification sound by means of the loudspeaker; and control the communication section to disconnect the telephone line.

According to this configuration, the communication device of the present invention includes the seismic intensity determination section for determining, if the earthquake early warning has been received while the telephone line is connected by means of the communication section, whether or not an estimated seismic intensity calculated by the earthquake information calculation section exceeds a predetermined threshold. If the seismic intensity determination section has determined that the estimated seismic intensity is less than the threshold, the disconnection processing section instructs the sound processing section to generate a notification sound notifying that the earthquake early warning has been received or that the telephone line is to be disconnected, and disconnects the telephone line.

Still further, the communication device of the present invention includes: a main communication device which includes the communication section, the earthquake information calculation section, the timer section, the sound processing section, the loudspeaker, the period determination section, the seismic intensity determination section, and the disconnection processing section; and a subordinate communication device which includes a second communication section operable to communicate with the main communication device, the disconnection processing section, the sound processing section, and the loudspeaker. If the main communication device has determined, by means of the period determination section, that the estimated period exceeds the threshold, or if the main communication device has determined, by means of the seismic intensity determination section, that the estimated seismic intensity is less than the threshold, then the main communication device provides the disconnection processing section of the subordinate communication device with a notification that the estimated period exceeds the threshold or that the estimated seismic intensity is less than the threshold. Upon receiving the notification, the disconnection processing section of the subordinate communication device performs the following: instruct the sound processing section to generate the notification sound; transmit the generated notification sound to the telephone line by means of the second communication section and output the generated notification sound by means of the loudspeaker; and control the communication section to disconnect the telephone line.

According to this configuration, the communication device of the present invention includes a base unit (=the main communication device) and a handset (=the subordinate communication device). The base unit includes the communication section, the earthquake information calculation section, the timer section, the sound processing section, the loudspeaker, the period determination section, the seismic intensity determination section, and the disconnection processing section. The handset includes the second communication section operable to communicate with the base unit, the disconnection processing section, the sound processing section, and the loudspeaker. If the base unit determines that the estimated period before the arrival of an earthquake exceeds the threshold, or that the estimated seismic intensity is less than the threshold, then the base unit provides a notification to the disconnection processing section of the handset. Upon receiving the notification, the disconnection processing section of the handset instructs the sound processing section to generate a notification sound, outputs the generated sound from the loudspeaker, and disconnects the telephone line.

Still further, the communication device of the present invention includes: a first communication section operable to connect to a communication network; an earthquake information calculation section for calculating earthquake information based on an earthquake early warning which the earthquake information calculation section receives from the communication network by means of the first communication section; a seismic intensity determination section for determining whether or not an estimated seismic intensity contained in the earthquake information exceeds a threshold; an announcement section for performing an announcement process based on the earthquake information, and performing a function ceasing process of ceasing a predetermined function among functions of the communication device during a predetermined period after the earthquake information calculation section has received the earthquake early warning; and an announcement control section for prohibiting the announcement section from performing the announcement process and the function ceasing process if the earthquake information calculation section has received the earthquake early warning and the seismic intensity determination section has determined that the estimated seismic intensity is less than the threshold which is predetermined.

According to this configuration, the communication device of the present invention includes the seismic intensity determination section for determining whether or not the estimated seismic intensity contained in the earthquake information exceeds the predetermined threshold. The communication device also includes the announcement section for announcing, based on the calculated earthquake information, the estimated seismic intensity, expected arrival time, and the like by means of a display, loudspeaker, and the like. The announcement section ceases a predetermined function of the communication device, for example, a phone call function, during a predetermined period after the earthquake information calculation section has received the earthquake early warning.

Moreover, the communication device of the present invention includes the announcement control section for controlling the announcement section based on a determination result provided by the seismic intensity determination section. In a case where an earthquake early warning is received and the estimated seismic intensity is determined to be less than the threshold, the announcement control section prohibits the announcement section from performing the announcement process based on earthquake information and the function ceasing process of ceasing a predetermined function. Accordingly, even during the predetermined period, the operation of the predetermined function is performed.

Still further, in the communication device of the present invention, the announcement control section performs, if the earthquake information calculation section has received the earthquake early warning while the predetermined function is operating and the seismic intensity determination section has determined that the estimated seismic intensity is less than the threshold, a reception notification when the function has ended operating, the reception notification indicating that the earthquake early warning has been received.

According to this configuration, in a case where an earthquake early warning is detected while the predetermined function is operating and the estimated seismic intensity is less than a predetermined value, the operation of the predetermined function continues and the announcement process is not performed. When the operation of the predetermined function has ended, the announcement control section performs a reception notification indicating that the earthquake early warning has been received during the operation of the predetermined function.

Still further, the communication device of the present invention includes: a main communication device which includes the first communication section, the earthquake information calculation section, the seismic intensity determination section, the announcement section, and the announcement control section; and a subordinate communication device which includes a second communication section operable to communicate with the main communication device. If the seismic intensity determination section has determined that the estimated seismic intensity is less than the threshold, the announcement control section prohibits the announcement process and the function ceasing process from being performed for the main communication device and the subordinate communication device.

According to this configuration, the communication device of the present invention includes a base unit and a handset. The base unit includes the first communication section, the earthquake information calculation section, the seismic intensity determination section, the announcement section, and the announcement control section. The handset includes the second communication section operable to communicate with the base unit. If the seismic intensity determination section has determined that the estimated seismic intensity is less than the threshold, the announcement control section prohibits the announcement process from being performed for the base unit and the handset, and also prohibits the function ceasing process of ceasing a predetermined function from being performed.

Still further, the communication device of the present invention includes: a main communication device which includes the first communication section and the earthquake information calculation section; and a subordinate communication device which includes a second communication section operable to communicate with the main communication device, the announcement section, the announcement control section, and the seismic intensity determination section. The main communication device transmits the earthquake information calculated by the earthquake information calculation section to the subordinate communication device by means of the first communication section. Upon receiving the earthquake information by means of the second communication section, the seismic intensity determination section of the subordinate communication device determines whether or not an estimated seismic intensity contained in the earthquake information exceeds the threshold. If the seismic intensity determination section has determined that the estimated seismic intensity is less than the threshold, the announcement control section prohibits the announcement section from performing the announcement process and the function ceasing process.

According to this configuration, the base unit includes the first communication section and the seismic intensity determination section. The handset includes the second communication section operable to communicate with the base unit, the announcement section, the announcement control section, and the seismic intensity determination section. Upon receiving an earthquake early warning, the base unit transmits calculated earthquake information to the handset. Upon receiving the earthquake information, the seismic intensity determination section of the handset compares the estimated seismic intensity with the threshold. If the estimated seismic intensity is determined to be less than the threshold as a result of the comparison, the announcement control section of the handset prohibits the announcement section from performing the announcement process and the function ceasing process.

### ADVANTAGEOUS EFFECTS OF THE INVENTION

The present invention configured as above includes the disconnection reason notification section. Therefore, even if a telephone line is forcibly disconnected since an earthquake early warning has been received during a phone call process, a notification that the earthquake early warning has been issued and the telephone line has been disconnected can be provided to a communication counterpart previously participating in the phone call process. This prevents a situation where a person of the communication counterpart side previously participating in the phone call process (hereinafter, the person is referred to as “the other party”) becomes confused and performs unnecessary operations, for example, repeatedly attempting to re-establish the connection.

According to the present invention configured as above, a notification that the earthquake early warning has been issued and the telephone line has been disconnected can be provided to the other party by an e-mail. This allows the notification process to be performed in parallel with the announcement process of the earthquake early warning. Thus, the announcement process is not hindered.

Further, according to the present invention configured as above, an e-mail containing a disconnection reason is transmitted to an e-mail address that is associated with the telephone number of the communication counterpart previously participating in the phone call process only when the telephone number of the communication counterpart is a mobile phone number. This is because an e-mail address associated with a mobile phone number is likely to be a mobile phone e-mail address. PC mailers lack the immediacy of mobile phone mailers. Therefore, e-mails are not transmitted to PC e-mail addresses, and this reduces the number of e-mail transmissions that are likely to be wasted.

Still further, according to the present invention configured as above, an e-mail containing a disconnection reason is transmitted only to an e-mail address that is registered in the address book as a mobile phone e-mail address. Accordingly, e-mails are not transmitted to PC e-mail addresses, and this reduces the number of e-mail transmissions that are likely to be wasted.

The present invention configured as above includes the rejection reason notification section. Therefore, even if there is an incoming call immediately after the reception of the earthquake early warning, that is, under a state of incoming call rejection, a notification that the earthquake early warning has been issued and phone calls are temporarily unavailable can be provided to the source of the incoming call. This prevents the other party from becoming confused and performing unnecessary operations, for example, repeatedly attempting to re-establish a connection.

Still further, according to the present invention configured as above, a notification that the earthquake early warning has been issued and phone calls are temporarily unavailable can be provided to the source of the incoming call by an e-mail. This allows the notification process to be performed in parallel with the announcement process of the earthquake early warning. Thus, the announcement process is not hindered.

Still further, according to the present invention configured as above, an e-mail containing a reason for the incoming call rejection is transmitted to an e-mail address that is associated with the telephone number of the source of the incoming call only when the source of the incoming call is a mobile phone number. Accordingly, e-mails are not transmitted to PC e-mail addresses, and this reduces the number of e-mail transmissions that are likely to be wasted.

Still further, according to the present invention configured as above, an e-mail containing a reason for the incoming call rejection is transmitted only to an e-mail address that is registered in the address book as a mobile phone e-mail address. Accordingly, e-mails are not transmitted to PC e-mail addresses, and this reduces the number of e-mail transmissions that are likely to be wasted.

According to the present invention configured as above, the telephone line is disconnected after a notification sound notifying that the earthquake early warning has been received or that the telephone line is to be disconnected is provided to the user of the communication device and the other party if the estimated period before the arrival of the earthquake exceeds the threshold. In this manner, not only the user of the communication device but also the other party can know that the earthquake early warning has been issued. This prevents the other party from becoming confused due to the disconnection, which is forcibly performed, and performing unnecessary operations, for example, repeatedly attempting to re-establish a connection. If the estimated period is short, the announcement of the earthquake early warning is prioritized. Thus, safety is not compromised.

Still further, according to the present invention configured as above, if the estimated seismic intensity of the earthquake is less than the threshold, the telephone line is disconnected after a notification sound notifying that the earthquake early warning has been received or that the telephone line is to be disconnected is provided to the user of the communication device and the other party. In this manner, not only the user of the communication device but also the other party can know that the earthquake early warning has been issued. If the estimated seismic intensity is great, the announcement of the earthquake early warning is prioritized. Thus, safety is not compromised.

Still further, according to the present invention configured as above, if the base unit determines that the estimated period exceeds the threshold or that the estimated seismic intensity is less than the threshold, then an instruction to perform a notification by sound is provided to the disconnection processing section of the handset. Accordingly, each of the base unit and the handset performs the notification independently. Therefore, the contents of the notification can be varied for each of multiple handsets, or some of the handsets may be set not to perform the notification process, for example.

Still further, according to the present invention configured as above, if the estimated seismic intensity is determined to be less than the threshold, the announcement control section prohibits the announcement section from performing the announcement process and the function ceasing process. As a result, the operation of the predetermined function is performed even during the predetermined period after the reception of the earthquake early warning. Thus, even during the predetermined period after the reception of the earthquake early warning, communication processing and the like by means of the communication device is available to the user.

Still further, according to the present invention configured as above, in a case where an earthquake early warning is detected during the operation of a predetermined function, for example, during a phone call process, and the announcement process is not performed since the estimated seismic intensity is less than the threshold, a reception notification indicating that the earthquake early warning has been received is performed when the operation of the predetermined function has ended, for example, when a phone call has ended. This allows the user to know, when the phone call has ended, that the earthquake early warning has been received during the phone call. This improves convenience.

Still further, according to the present invention configured as above, the present invention is applicable to an extension telephone system that includes a base unit and a handset. Thus, even if a user of the extension telephone system receives, while in use of the system, an earthquake early warning for an earthquake of a small estimated seismic intensity, the use of the extension telephone system by the user is not disrupted and the user can continue a phone call or the like.

Still further, according to the present invention configured as above, the handset included in the communication device includes the announcement section, the announcement control section, and the seismic intensity determination section. Accordingly, the present invention can be applied only to the handset of the extension telephone system while the base unit performs the announcement process in a conventional manner.

### BRIEF DESCRIPTION OF THE DRAWINGS

FIG. 1 is a block diagram showing a configuration of a telephone system of the present invention.

FIG. 2 is a block diagram showing a configuration of a base unit among communication devices according to a first embodiment.

FIG. 3 is a block diagram showing a configuration of a handset among the communication devices according to the first embodiment.

FIG. 4 is a flowchart showing a processing flow of a disconnection reason notification process according to the first embodiment.

FIG. 5 is a block diagram showing a configuration of a base unit among communication devices according to a second embodiment.

FIG. 6 is a flowchart showing a processing flow of a rejection reason notification process according to the second embodiment.

FIG. 7 is a block diagram showing a configuration of a base unit among communication devices according to a third embodiment.

FIG. 8 is a block diagram showing a configuration of a handset among the communication devices according to the third embodiment.

FIG. 9 is a flowchart showing a processing flow of an announcement process according to the third embodiment.

FIG. 10 is a block diagram showing a configuration of a base unit among communication devices according to a fourth embodiment.

FIG. 11 is a flowchart showing a processing flow of an announcement process according to the fourth embodiment.

FIG. 12 is a block diagram showing a configuration of a base unit among communication devices according to a fifth embodiment.

FIG. 13 is a flowchart showing a processing flow of an announcement process according to the fifth embodiment.

FIG. 14 is a block diagram showing a configuration of a handset among communication devices according to a sixth embodiment.

FIG. 15 is a flowchart showing a processing flow of an announcement process according to the sixth embodiment.

### DESCRIPTION OF THE REFERENCE CHARACTERS

1 base unit (communication device, main communication device)
11 control section
11a earthquake information calculation section
11b number determination section
11c disconnection reason notification section
11d mail transmission section
11e announcement section
11f disconnection processing section
11g rejection reason notification section
11h preparation period determination section (period determination section)
11i estimated seismic intensity determination section (seismic intensity determination section)
11j announcement control section
15 communication control section (communication section, first communication section)
16 antenna device (radio communication section)
17 sound signal processing section (sound processing section)
20 clock circuit (timer section)
2 handset (subordinate communication device)
21a disconnection processing section
21b seismic intensity determination section
21c announcement section
21d announcement control section
25 communication control section (second communication section)
26 antenna device (radio communication section)
27 sound signal processing section (sound processing section)
31 flash memory (storage section)
32 flash memory (storage section)

### BEST MODE FOR CARRYING OUT THE INVENTION

Hereinafter, embodiments of the present invention are described with reference to the drawings. Note that the embodiments herein are merely illustrative and the present invention is not limited to these embodiments.

### First Embodiment

### <1-1. Configuration of Telephone System>

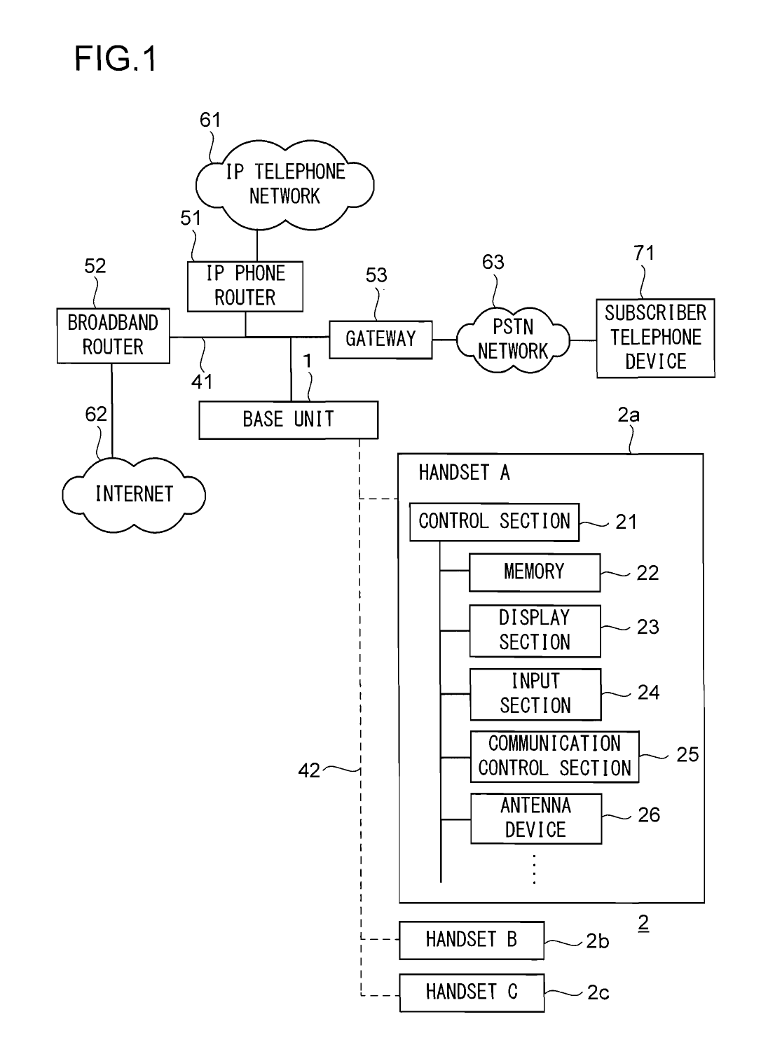

FIG. 1 is a block diagram showing a configuration of a telephone system that includes cordless telephone devices (=communication devices) of the present invention. The system includes at least a base unit 1 (=a main communication device), handsets 2 (=subordinate communication devices), wired LAN 41, a wireless communication network 42, an IP phone router 51, a broadband router 52, a gateway 53, an IP telephone network 61, the Internet 62, a PSTN network 63 (=Public Switched Telephone Network), and a subscriber telephone device 71.

The cordless telephone devices of the present invention are connectable to an IP communication network. In FIG. 1, the base unit 1 and the plurality of handsets 2 (a handset A2a to a handset C2c) are the cordless telephone devices. The base unit 1 is an IP phone device that is capable of voice communication via a telephone network when connected to the wired LAN 41. The base unit 1 also has a relay function of relaying communication between the wired LAN 41 and the wireless communication network 42. Accordingly, by means of the handsets 2 which are described below, phone calls can be made via the IP telephone network 61 or the PSTN network 63, which phone calls are relayed by the base unit 1. Further, the base unit 1 has a function of receiving, via the Internet 62, an earthquake early warning distributed by a meteorological agency. Note that an internal configuration of the base unit 1 is described below in detail.

The handsets 2 are wireless telephone devices connected to the below-described wireless communication network 42 and communicate with the base unit 1. Accordingly, each handset 2 is capable of voice communication with other telephone devices via the IP telephone network 61 or the PSTN network 63. Note that an internal configuration of the handsets 2 is described below in detail.

The wired LAN 41 is a local network in which the base unit 1, the IP phone router 51, the broadband router 52, the gateway 53, and the like are connected by cables. These devices can communicate with one another by being connected to the wired LAN 41. Note that the physical means for configuring the wired LAN 41 is, for example, 10BASE-T (specified in the IEEE802.3i standard) or 100BASE-TX (specified in the IEEE802.3u standard) using a twisted pair cable.

The wireless communication network 42 is a small-scale communication network in which the base unit 1 and the plurality of handsets 2 are wirelessly connected. To be specific, for example, the base unit 1 and the handsets 2 communicate with one another by using a communication method such as one compliant with FHSS-WDCT (Frequency Hopping Spread Spectrum-Worldwide Digital Cordless Telephone), which uses radio waves in the 2.4 GHz frequency band.

The IP phone router 51 and the broadband router 52 are each a network relay device for connecting a plurality of IP networks with each other. To be specific, the IP phone router 51 and the broadband router 52 each analyzes part of the protocol of the Network Layer (Layer 3) and of the Transport Layer (Layer 4) of the OSI (Open Systems Interconnection) Reference Model to perform transfer. In the present embodiment, the IP phone router 51 has a role of interconnecting two IP networks that are the wired LAN 41 and the IP telephone network 61. Also, the broadband router 52 has a role of interconnecting two IP networks that are the wired LAN 41 and the Internet 62.

The gateway 53 is a protocol converter for interconnecting networks that use different protocols. For example, the gateway 53 connects the wired LAN 41 and the PSTN network 63, and performs signal conversion using a signaling protocol such as the SIP. This enables communication between these networks.

The IP telephone network 61 is a communication network where the VoIP (Voice over Internet Protocol) technology is applied to the whole or part of the network. A communication line used in the IP telephone network 61 is a so-called broadband line such as FTTH (Fiber To The Home) or ADSL (Asymmetric Digital Subscriber Line). Note that the VoIP is a technology for compressing and converting a voice into packets by various coding methods and transferring the packets in real time over an IP network. This makes it possible to provide, over the IP telephone network 61, not only voice call services but also, for example, video phone services for transmitting/receiving images.

The Internet 62 is a wide area communication network which is constructed by interconnecting networks that are based on communication protocols. Various computer networks different in scale are joined to one another to construct an international communication network. The TCP/IP protocols which are standard communication protocols are adopted for the Internet 62 as main communication protocols.

The PSTN network 63 is a general subscriber telephone network. The network has telephone devices connected to the edge thereof, and is used to allow a telephone subscriber to make a voice call by establishing a connection with the other party by a line switching system. The subscriber telephone device 71 is a telephone device for a telephone subscriber to make a voice call to another subscriber telephone device or IP phone device, by using the PSTN network 63.

### <1-2. Internal Configuration of Base Unit>

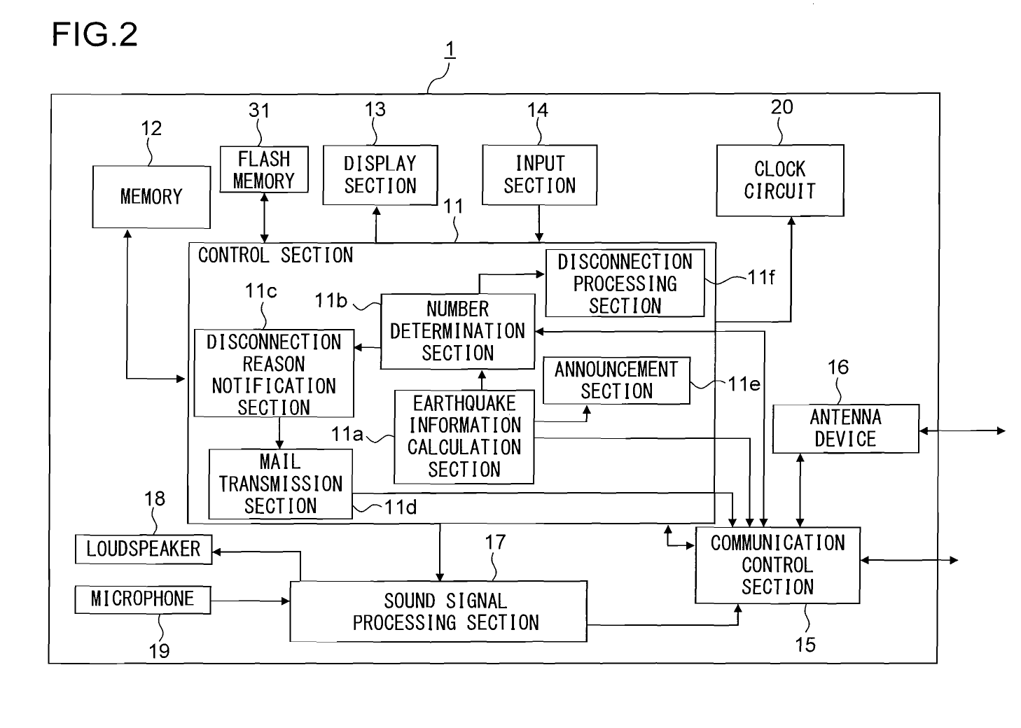

FIG. 2 is a block diagram showing the internal configuration of the base unit 1 according to the first embodiment of the present invention. The base unit 1 includes at least a control section 11, a memory 12, a display section 13, an input section 14, a communication control section 15 (=a communication section, a first communication section), an antenna device 16 (=a radio communication section), a sound signal processing section 17 (=a sound processing section), a loudspeaker 18, a microphone 19, a clock circuit 20 (=a timer section), and a flash memory 31 (=a storage section).

The control section 11 is a central processing unit which controls the respective components of the base unit 1, thereby performing comprehensive control of communication control processing (e.g., transmission/reception of sound data, performing outgoing calls, and detecting incoming calls). The control section 11 includes an earthquake information calculation section 11a, a number determination section 11b, a disconnection reason notification section 11c, a mail transmission section 11d, an announcement section 11e, and a disconnection processing section 11f, as functional blocks that are implemented when a program is executed by an arithmetic processing unit of the control section 11.

The earthquake information calculation section 11a receives an earthquake early warning from the Internet 62 by using the communication control section 15. The earthquake early warning contains data, such as, an earthquake detection time, an earthquake identification number, an epicenter geographical name code, the latitude/longitude of the epicenter, the depth of the hypocenter, the magnitude of the earthquake, an estimated maximum seismic intensity, accuracy of data (in connection with a system, processing method, and the like used in the measurement), and the like. However, an estimated seismic intensity and an estimated period before the arrival of the principal shock, which are contained in the earthquake early warning, are rough estimations. Therefore, it is necessary for the receiver side to calculate a specific estimated seismic intensity and the like for the corresponding area.

There are two main types of processing for the calculation, which are single-station processing and multi-station processing. The single-station processing is local, spot-focused measurement processing, such as the P-wave detection or the level method, which is performed on the assumption that an earthquake has occurred near the station. The multi-station processing is for calculating an estimated seismic intensity and a principal shock arrival time for a specific location, by using results of the single-station processing by multiple stations. Typical processing methods include the territory method and the grid search method.

The earthquake information calculation section 11a performs multi-station processing based on results of single-station processing that are included in an earthquake early warning and latitude/longitude information stored in the memory 12. Specifically, for example, firstly, three elements of the earthquake are obtained from results of single-station processing by multiple stations (epicenter: X, Y; time: T; magnitude: M). Further, an epicentral distance D at a specific location (i.e., a distance from the epicenter X, Y to the specific location X₀, Y₀) is obtained, and also, a felt radius R is obtained from the magnitude M of the earthquake. Here, the specific location refers to the latitude/longitude of the location of the base unit 1.

The earthquake information calculation section 11a obtains a standard intensity Sr at the specific location based on the epicentral distance D, the magnitude M of the earthquake, and the depth H of the hypocenter, and then obtains an amplification factor A for the specific location based on its geological conditions and the like. The earthquake information calculation section 11a uses the standard intensity Sr and the amplification factor A, thereby obtaining an estimated intensity, maximum velocity, maximum acceleration, maximum displacement, expected arrival time, and the like of the principal shock (S-wave). Note that the calculation method used by the earthquake information calculation section 11a is not limited to the above, but may be modified as necessary so as to accord with its manner of application and the data contained in the earthquake early warning.

When the communication control section 15 has established a telephone line connection with the subscriber telephone device 71 via the PSTN network 63 and the like, the number determination section 11b obtains the telephone number of the other party (hereinafter, referred to as “the other party's number”). Note that the number determination section 11b obtains the other party's number based on a caller's number that is notified by the other party at the time of receiving an incoming call, for example. Alternatively, in a case of making an outgoing call, the number determination section 11b obtains, as the other party's number, a telephone number that is inputted via the input section 14 at the time of making the outgoing call.

Further, the number determination section 11b performs determination as to whether the other party's number, which has been obtained, is a mobile phone number (hereinafter, referred to as a “mobile number”). To be specific, for example, the other party's number is determined to be a mobile number when the first three digit numbers of the other party's number are 070, 080, or 090. If the first three digit numbers are different from such numbers, or if the other party's number indicates a public phone number or no number display, then the other party's number is determined not to be a mobile number. The determination result is provided to the disconnection reason notification section 11c.

In a case where the telephone line is forcibly disconnected when the earthquake information calculation section 11a has detected an earthquake early warning, the disconnection reason notification section 11c confirms the determination result which the number determination section 11b has provided in relation to the other party's number. If the other party's number is a mobile number, the disconnection reason notification section 11c reads, from an address book (=association information) stored in the flash memory 31 or the like, an e-mail address that is associated with the other party's number. Then, the disconnection reason notification section 11c instructs the mail transmission section 11d to generate and transmit an e-mail of a fixed phrase to the read e-mail address. Here, such a fixed phrase is, for example, “Line has been disconnected due to the reception of an earthquake early warning”.

If the other party's number is not a mobile number, the disconnection reason notification section 11c determines whether or not the e-mail address associated with the other party's number is a mobile phone e-mail address (hereinafter, referred to as a “mobile address”). If the e-mail address is determined to be a mobile address, the disconnection reason notification section 11c instructs the mail transmission section 11d to generate and transmit an e-mail of the fixed phrase to the mobile address.

Whether or not the e-mail address is a mobile address is determined based on, for example, setting information that is set in advance in the address book. In a case where a user of the cordless telephone device registers an e-mail address in the address book, the control section 11 performs reception for a PC e-mail address and for a mobile address, separately. Then, the control section 11 stores, as setting information in the address book, information indicating which type of address has been received.

Accordingly, the disconnection reason notification section 11c can determine based on the setting information whether or not the e-mail address is a mobile address. Note that the other party's telephone number, mobile address, PC address, residential address, name, etc., can be registered in the address book in association with one another.

The mail transmission section 11d communicates, by means of the communication control section 15, with a mail server that is connected to the IP communication network. Accordingly, the mail transmission section 11d has a mail client function for generating and transmitting e-mails. For example, the mail transmission section 11d transmits e-mails by connecting to an SMTP (Simple Mail Transfer Protocol) server or the like that provides an e-mail transmission service. Alternatively, the mail transmission section 11d may use a specific service provided by a telecommunications carrier, for example, a mobile phone service, the L-mode service, or the like, to transmit e-mails via a radio communication line used by mobile phones or a general telephone line.

The announcement section 11e performs an announcement process in relation to an earthquake according to earthquake information calculated by the earthquake information calculation section 11a. For example, the announcement section 11e displays, by means of the display section 13, an image that indicates an expected arrival time of the principal shock, an estimated seismic intensity, and the like. Also, the announcement section 11e outputs, by means of the sound signal processing section 17 and the loudspeaker 18, sounds that indicate the expected arrival time of the principal shock, the estimated seismic intensity, and the like.

Further, during a predetermined period after the reception of the earthquake early warning, the announcement section 11e causes the base unit 1 and the handsets 2 to enter a state where predetermined functions are ceased (hereinafter, referred to as a “function ceased state”) for the purpose of prioritizing the announcement process. Here, functions to be ceased include, for example, a phone call function and an e-mail transmission/reception function that are realized by the communication control section 15 or the like.

If the earthquake information calculation section 11a has received an earthquake early warning while a telephone line is connected, the disconnection processing section 11f instructs the communication control section 15 to disconnect the telephone line. Accordingly, for example, if a phone call process is being performed at the time of receiving an earthquake early warning, the phone call process is forcibly ended.

The memory 12 is a storage medium for temporality storing various data retained by the base unit 1, and is structured as a writable RAM (Random Access Memory), for example. The memory 12 serves as a buffer memory for temporarily storing data processed in various communication control processing performed by the control section 11, instruction commands received from the user, etc.

The display section 13 displays, to the user, various information that the base unit 1 retains (e.g., a telephone number of a caller that is obtained when an incoming call is received). For example, a display device such as a liquid crystal panel that is small in size and consumes small amount of power is used for the display section 13. The input section 14 is provided for the user to perform various operations (e.g., entering the telephone number of the other party to which the user makes a phone call) for communication using the base unit 1. Generally, the input section 14 includes a plurality of operation buttons, such as numerical buttons and a redial button.

The communication control section 15 is a communication interface for connecting the base unit 1 to the wired LAN 41. The communication control section 15 can perform incoming call processing, outgoing call processing, etc., in an IP telephone system by communicating with a call control server (not shown) which is connected to the wired LAN 41. The communication control section 15 also controls radio communication that is performed, using the antenna device 16, via the wireless communication network 42.

The antenna device 16 is a radio communication device for transmitting/receiving radio communication waves to/from the handsets 2. The antenna device 16 performs radio communication in accordance with, for example, a communication method compliant with a predetermined communication standard such as FHSS-WDCT (Frequency Hopping Spread Spectrum-Worldwide Digital Cordless Telephone). Accordingly, the base unit 1 can perform voice communication, data communication, and the like with the handsets 2.

The sound signal processing section 17 performs a decoding process of decoding sound data that is inputted thereto by the communication control section 15, and then provides the resultant sound signal to the loudspeaker 18. The sound signal processing section 17 provides the communication control section 15 with sound information that the sound signal processing section 17 generates by performing a predetermined encoding process of encoding a sound signal that is inputted from the microphone 19, and sound information that is prestored in the flash memory 31. Accordingly, these pieces of sound information are transmitted to another telephone device that is connected to the base unit 1 via the wired LAN 41, the wireless communication network 42, or the IP telephone network 61, for example.

The clock circuit 20 is a circuit for keeping the current time. The clock circuit 20 keeps time by using, for example, a crystal oscillator that oscillates at a predetermined frequency. The clock circuit 20 is capable of managing not only temporal information but also calendar information relating to a calendar, such as, the current month, date, and day of the week.

The flash memory 31 is a storage device for temporarily storing various data retained by the base unit 1. The flash memory 31 has a role of storing: sound information that the sound signal processing section 17 uses to generate sound signals; processed data that is generated when various controls are performed; user data such as the address book; setting data; and the like. The flash memory 31 is a nonvolatile storage medium which does not allow rewriting to be performed byte by byte. The flash memory 31 only allows rewriting to be performed sector by sector or block by block.

### <1-3 Internal Configuration of Handset>

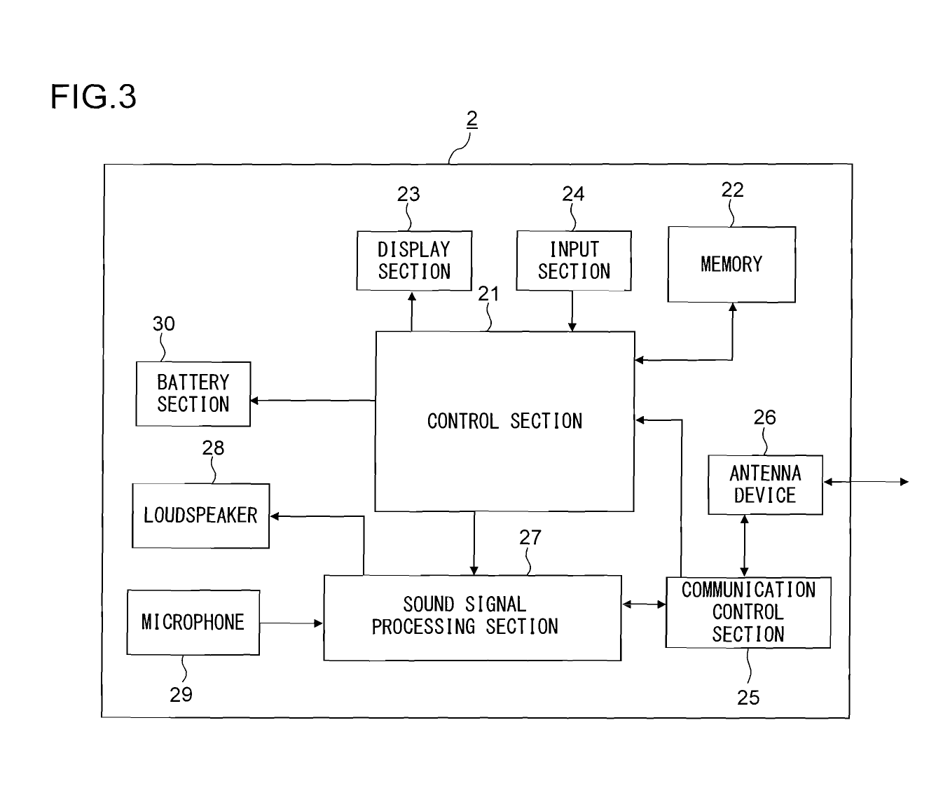

FIG. 3 is a block diagram showing an internal configuration of the handsets 2 according to the first embodiment of the present invention. Each handset 2 includes at least a control section 21, a memory 22, a display section 23, an input section 24, a communication control section 25 (=a second communication section), an antenna device 26 (=radio communication section), a sound signal processing section 27 (=sound processing section), a loudspeaker 28, a microphone 29, and a battery section 30.

The control section 21 is a central processing unit, which controls the respective components of the handset 2, thereby performing comprehensive control of communication control processing (e.g., transmission/reception of sound data, performing outgoing calls, and detecting incoming calls). The memory 22 is a storage medium for temporarily storing various data retained by the handset 2. The memory 22 is structured as, for example, a writable RAM (Random Access Memory). The memory 22 serves as a buffer memory for temporarily storing data processed in various communication control processing performed by the control section 21, instruction commands received from a user, etc.

The display section 23 displays, to the user, various information that the handset 2 retains (e.g., a telephone number of a caller that is obtained when an incoming call is received). For example, a display device such as a liquid crystal panel that is small in size and consumes small amount of power is used for the display section 23. The input section 24 is provided for the user to perform various operations (e.g., entering the telephone number of the other party to which the user makes a phone call) for communication using the handset 2. Generally, the input section 24 includes a plurality of operation buttons, such as numerical buttons and a redial button.

The communication control section 25 controls radio communication that is performed by using the antenna device 26. This allows the handset 2 to communicate with the base unit 1 which is connected to the wireless communication network 42. The communication control section 25 can perform incoming call processing, outgoing call processing, and the like via the PSTN network 63, which are relayed by the base unit 1.

Since the antenna device 26 to the microphone 29 have the same configurations as those of the antenna device 16 to the microphone 19 of the base unit 1, respectively, the descriptions thereof are omitted herein. The battery section 30 is fed with power from an external power source (not shown), and temporarily stores the power. For example, a rechargeable alkaline battery or a lithium-ion battery is used for the battery section 30.

### <1-4. Disconnection Reason Notification Process>

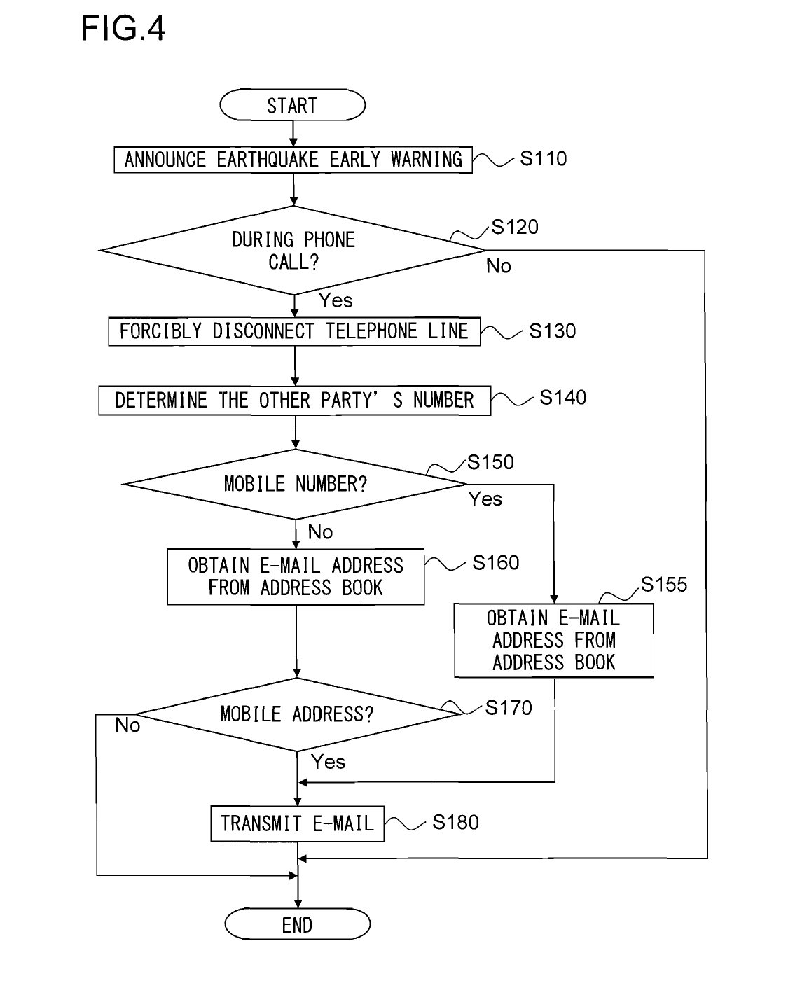

Described hereinafter with reference to block diagrams of FIG. 1 to FIG. 3 and a flowchart of FIG. 4 is a disconnection reason notification process which is performed using the base unit 1 and the handset 2 of the first embodiment of the present invention at the time of receiving an earthquake early warning.

FIG. 4 shows a flow of processing of the base unit 1 of the present embodiment. The processing flow shown in FIG. 4 starts when the power of the base unit 1 is turned on and the base unit 1 has detected that an earthquake early warning has been received via a communication network such as the LAN 41. After the processing has started, the earthquake information calculation section 11a calculates, at step S110 and based on earthquake information contained in the earthquake early warning, an estimated seismic intensity, an expected arrival time of the principal shock, and the like. Based on the calculation results, the announcement section 11e performs the announcement process by using an image or sound.

Next, at step S120, the disconnection processing section 11f checks the status of processing of the communication control section 15, and determines whether or not a telephone line is in a state of connection and a phone call process is being performed. If it is determined that a phone call process is not being performed, it is not necessary to perform the disconnection reason notification process. Therefore, the processing ends. If it is determined that a phone call process is being performed, the disconnection processing section 11f forcibly disconnects the telephone line at step S130.

Next, at step S140, the number determination section 11b obtains the other party's number in relation to the telephone line previously connected until the reception of the earthquake early warning, that is, the telephone line forcibly disconnected at step S130. Then, the number determination section 11b determines at step S150 whether or not the other party's number, which has been obtained, is a mobile number. The determination result is provided to the disconnection reason notification section 11c.

If it is determined that the other party's number is a mobile number, then at step S155, the disconnection reason notification section 11c obtains, from the address book, an e-mail address that is associated with the other party's number. Subsequently, at step S180, the disconnection reason notification section 11c instructs the mail transmission section 11d to generate and transmit, to the obtained e-mail address, an e-mail that contains a fixed phrase indicating a disconnection reason. When the process of transmitting the e-mail by the mail transmission section 11d is completed, the processing ends.

Now, the description returns to step S150. If it is determined at step S150 that the other party's number is not a mobile number, then at step S160, the disconnection reason notification section 11c obtains, from the address book, an e-mail address that is associated with the other party's number. Further, at step S170, the disconnection reason notification section 11c determines based on setting information contained in the address book whether or not the obtained e-mail address is a mobile address.

If it is determined that the obtained e-mail address is a mobile address, then at S180, the disconnection reason notification section 11c instructs the mail transmission section 11d to generate and transmit, to the obtained e-mail address, an e-mail that contains a fixed phrase indicating a disconnection reason. When the process of transmitting the e-mail by the mail transmission section 11d is completed, the processing ends.

If it is determined at step S170 that the obtained e-mail address is not a mobile address, for example, if the obtained e-mail address is determined to be a PC e-mail address, the e-mail transmission process is not performed and the processing ends since PC e-mail addresses lack the immediacy of mobile addresses in terms of conveyance of information.

According to the present embodiment as described above, in a case where a telephone line is forcibly disconnected during a phone call due to the reception of an earthquake early warning, a notification that the telephone line has been forcibly disconnected in response to the issuance of the earthquake early warning can be provided to the other party to the call. This prevents the other party from becoming confused and performing unnecessary operations, for example, repeatedly attempting to re-establish a connection.

Further, according to the present embodiment, the notification that the telephone line has been disconnected in response to the issuance of the earthquake early warning is provided to the other party by e-mail. Therefore, the notification process can be performed in parallel with the announcement process of the earthquake early warning. The e-mail is transmitted only to an address associated with a mobile number or to a mobile address, and not to a PC e-mail address or the like which lacks immediacy. As a result, the number of e-mails that are likely to be wasted is reduced.

Next, a second embodiment of the present invention is described with reference to the drawings.

### Second Embodiment

<2-1. Configuration of Telephone System>

Since the configuration of the telephone system of the second embodiment is the same as that described in the first embodiment, the description thereof is omitted herein.

<2-2. Internal Configuration of Base Unit>

In the base unit 1 of the present embodiment, the control section 11 includes a rejection reason notification section 11g in place of the disconnection reason notification section 11c of the first embodiment.

In a case where the earthquake information calculation section 11a has detected an earthquake early warning and the control section 11 has rejected an incoming call within a predetermined period after the detection, the rejection reason notification section 11g requests a telephone line connection to the source number (=source telephone number) of the incoming call. When the telephone line is successfully connected, the rejection reason notification section 11g instructs the sound signal processing section 17 to generate and transmit a fixed message that indicates a reason for the incoming call rejection. Note that the fixed message is, for example, a sound message such as “Due to the reception of an earthquake early warning, calls will not be answered for a while”.

<2-3. Internal Configuration of Handset>

Since the internal configuration of the handset of the second embodiment is the same as that described in the first embodiment, the description thereof is omitted herein.

<2-4. Rejection Reason Notification Process>

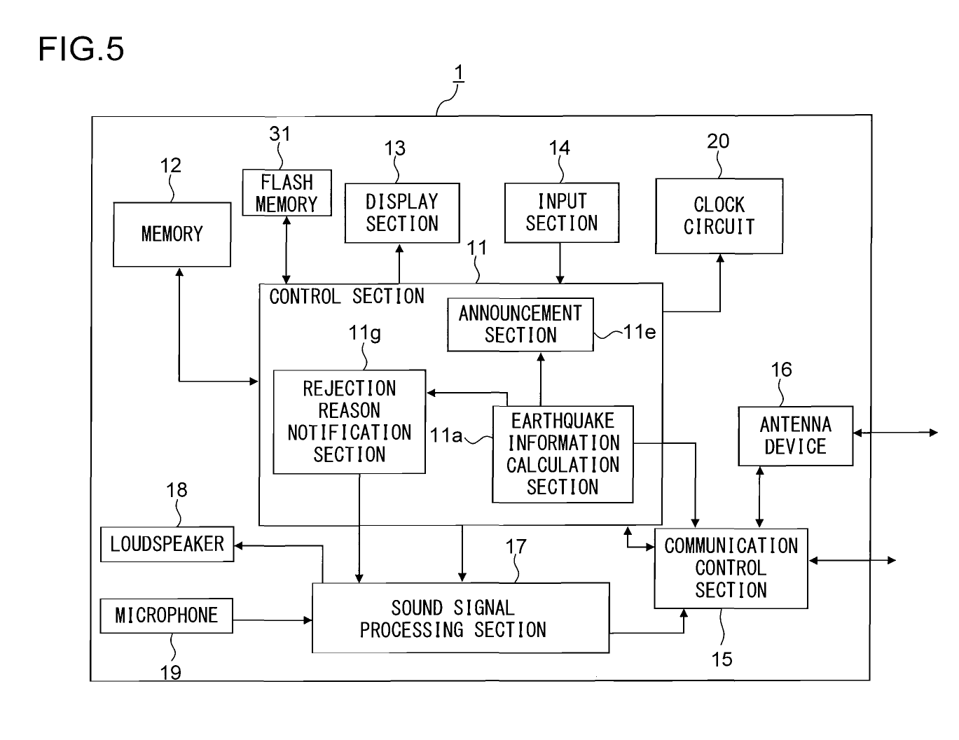

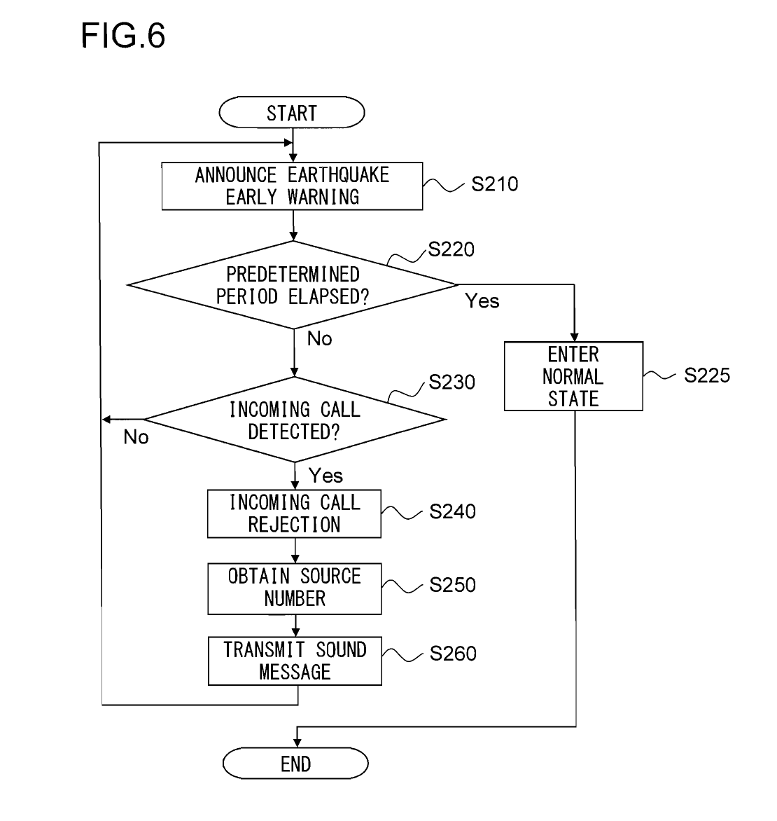

Described hereinafter with reference to a block diagram of FIG. 5 and a flowchart of FIG. 6 is a rejection reason notification process which is performed using the base unit 1 and the handset 2 of the second embodiment of the present invention at the time of receiving an earthquake early warning.

FIG. 6 shows a flow of processing of the base unit 1 of the present embodiment. The processing flow shown in FIG. 6 starts when the power of the base unit 1 is turned on and the base unit 1 has detected that an earthquake early warning has been received via a communication network such as the LAN 41. After the processing has started, the earthquake information calculation section 11a calculates, at step S210 and based on earthquake information contained in the earthquake early warning, an estimated seismic intensity, an expected arrival time of the principal shock, and the like. Based on the calculation results, the announcement section 11e performs the announcement process by using an image or sound.

Next, at step S220, the control section 11 determines whether or not a predetermined period has elapsed after the announcement of the earthquake early warning has started. If the predetermined period has elapsed, then at step S225, the control section 11 causes the base unit 1 to enter a normal standby state and ends the processing.

If it is determined that the predetermined period has not elapsed, then at step S230, the announcement section 11e determines whether or not the communication control section 15 has detected an incoming call. If the communication control section 15 has not detected an incoming call, the processing returns to step S210. If the communication control section 15 has detected an incoming call, then at step S240, the announcement section 11e rejects the incoming call for the purpose of prioritizing the announcement process of the earthquake early warning.

Next, at step S250, the rejection reason notification section 11g obtains the source number of the rejected incoming call. Then, at step S260, the rejection reason notification section 11g requests a telephone line connection to the obtained source number. When a telephone line is successfully connected, the rejection reason notification section 11g instructs the sound signal processing section 17 to transmit a sound message that indicates a reason for the incoming call rejection. When the process of transmitting the sound message by the sound signal processing section 17 is completed, the processing returns to step S210.

Note that if a telephone line is not connected even after the telephone line connection request has been made a predetermined number of times at step S260, then no sound message is transmitted and the processing shifts to step S210.

According to the present embodiment described above, in a case where the announcement section 11e rejects an incoming call for the purpose of prioritizing the announcement process after the reception of an earthquake early warning, a notification of the reason for the incoming call rejection can be provided to the communication requesting side (=the source number of the incoming call). Accordingly, the notification process can be performed in parallel with the announcement process of the earthquake early warning. Thus, the announcement process is not hindered.

Next, a third embodiment of the present invention is described with reference to the drawings.

### Third Embodiment

### <3-1. Configuration of Telephone System>

Since the configuration of the telephone system of the third embodiment is the same as that described in the first embodiment, the description thereof is omitted herein.

### <3-2. Internal Configuration of Base Unit>

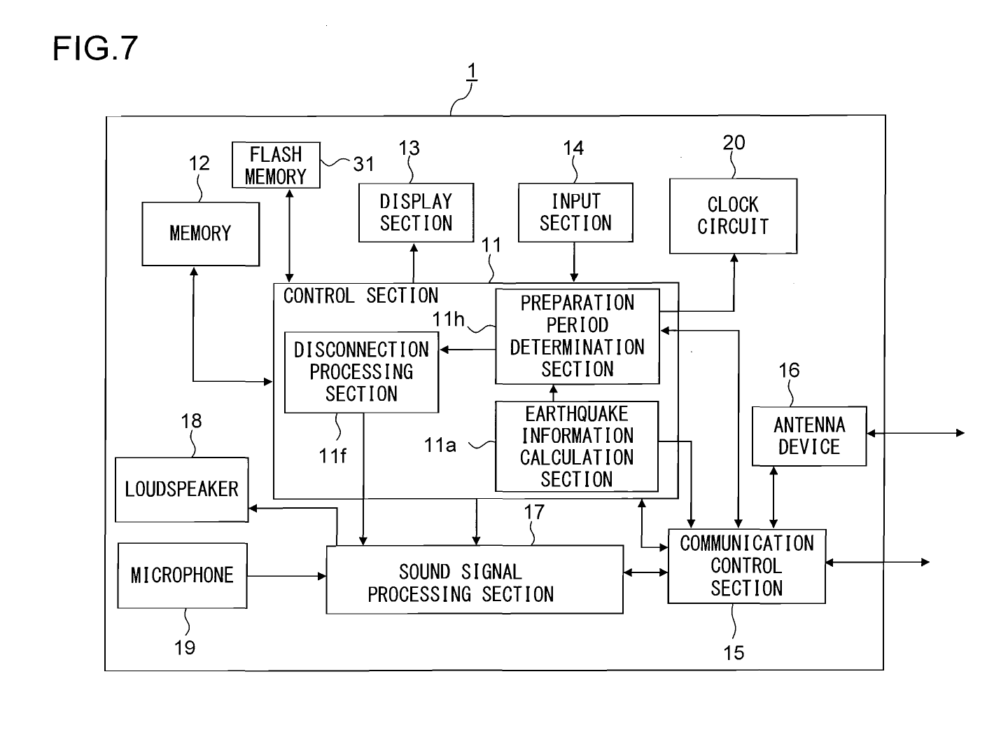

As shown in FIG. 7, the base unit 1 of the present embodiment includes a preparation period determination section 11h (=a period determination section) in addition to the earthquake information calculation section 11a and the disconnection processing section 11f of the first embodiment. Moreover, the function of the disconnection processing section 11f is partially different from that described in the first embodiment.

Based on the expected arrival time of the principal shock, which is calculated as described above, and the current time kept by the clock circuit 20, the preparation period determination section 11h calculates an estimated period before the principal shock arrives, that is, a period during which the user can take evacuation actions (hereinafter, referred to as a “preparation period”). Then, the preparation period determination section 11h determines whether or not a value indicating the calculated preparation period (hereinafter, referred to as a “preparation period T”) exceeds a predetermined threshold (hereinafter, referred to as a “threshold Ta”. The determination result is provided to the disconnection processing section 11f and a disconnection processing section 21a.

Note that the value of the threshold Ta used by the preparation period determination section 11h is stored in a storage medium such as the flash memory 31 as factory setting, for example. Alternatively, the user may be allowed to set the value by using a setting screen or the like. In this case, however, in order to ensure safety, it is desired that the lower limit of the threshold Ta is set so that the threshold Ta cannot be set to an excessively low value.

In a case where the determination result provided by the preparation period determination section 11h indicates T>Ta, the disconnection processing section 11f of the present embodiment instructs the sound signal processing section 17 to generate a notification sound notifying the user of the base unit 1 and the other party that an earthquake early warning has been issued and a telephone line currently connected is to be disconnected.

Upon receiving the instruction, the sound signal processing section 17 reads sound information prestored in the flash memory 31 and performs a decoding process of decoding the sound information, and outputs the result of the decoding from the loudspeaker 18. Also, the sound signal processing section 17 transmits the result of the decoding to the other party by means of the communication control section 15. The notification sound used here is, for example, a voice message such as “An earthquake early warning has been received and your telephone will be disconnected”. Note that it is desired that the notification sound is as simple and short as possible.

Here, whether or not to mute the telephone voice by means of a mute circuit (not shown) of the sound signal processing section 17 may be changed as necessary depending on the manner of application. For example, in a case where muting is not set to be performed, the notification sound superimposed on the telephone voice is outputted from the loudspeaker 18. The same is true for the telephone voice transmitted to the other party's communication device.

In a case where muting is set to be performed, only the notification sound is outputted from the loudspeaker 18. In such a case, the user can be focused on listening to the notification sound although the user cannot continue the phone call.

After performing the notification by sound as described above, the control section 11 performs the announcement process of the earthquake early warning in a normal manner. Accordingly, for example, a countdown sound such as “The earthquake will arrive in 9 seconds, 8 seconds, 7 seconds . . . ” is outputted.

<3-3. Internal Configuration of Handset>

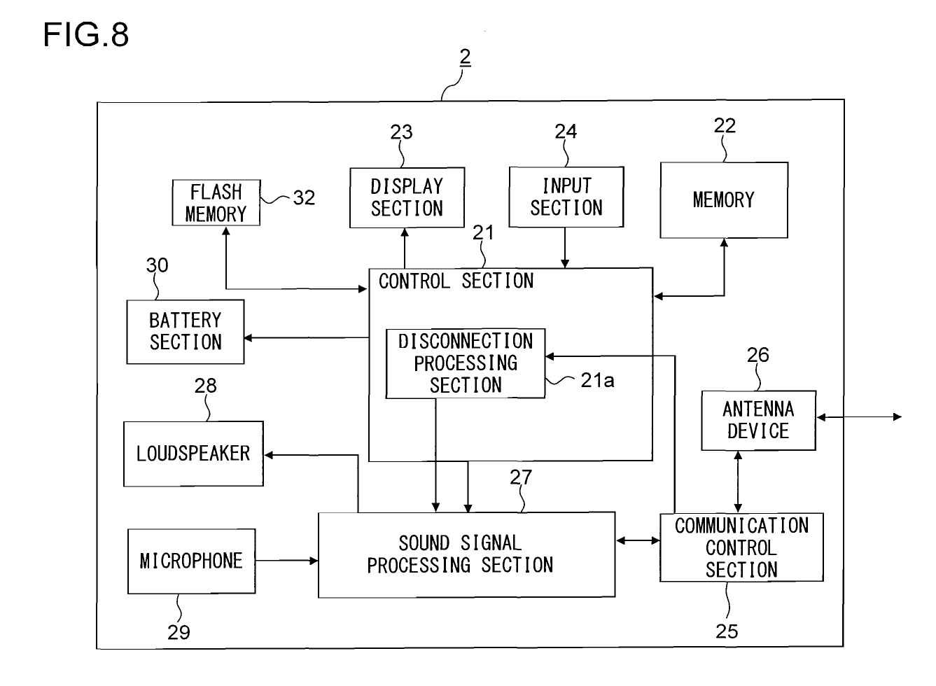

As shown in FIG. 8, the handset 2 of the present embodiment includes the disconnection processing section 21a as a functional block that is implemented when a program is executed by an arithmetic processing unit of the control section 21.

In a case where a determination result provided from the preparation period determination section 11h via the wireless communication network 42 indicates T>Ta, the disconnection processing section 21a instructs the sound signal processing section 27 to notify the user of the handset 2 and the other party that an earthquake early warning has been issued and a telephone line currently connected is to be disconnected. Upon receiving the instruction, the sound signal processing section 27 reads sound information prestored in the flash memory 32 (=the storage section) and outputs the sound information from the loudspeaker 28. Also, the sound signal processing section 27 transmits the sound information to the other party by means of the communication control section 25.

<3-4. Evacuation Instruction Process>

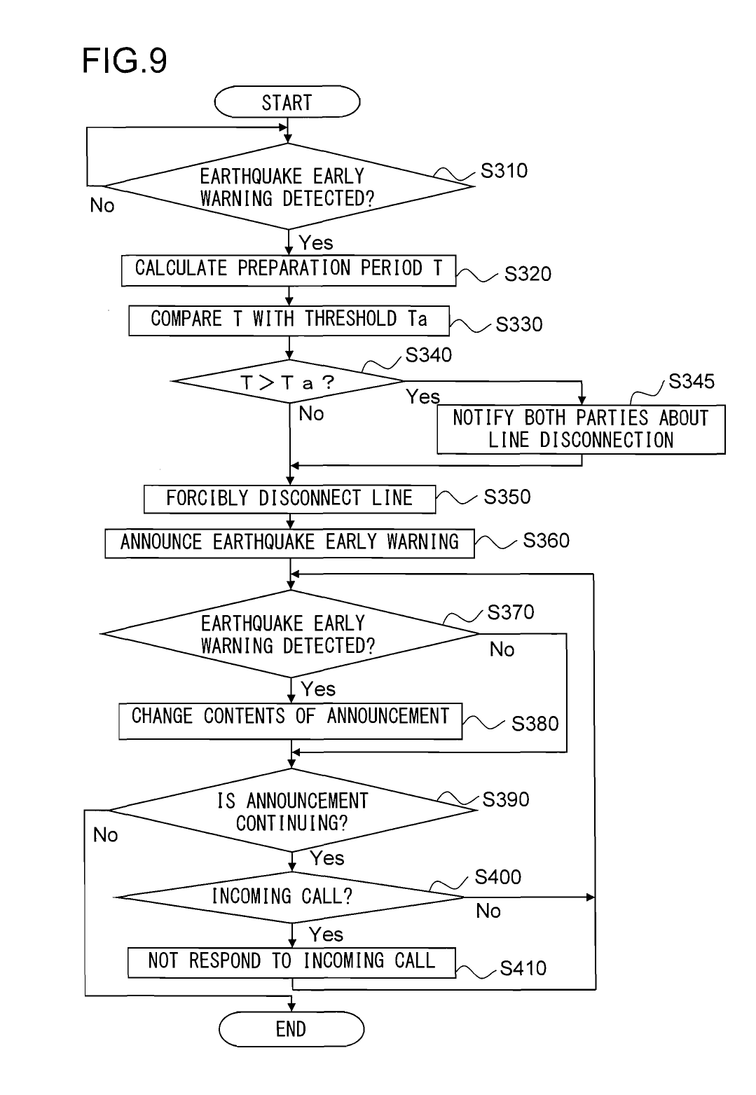

Described hereinafter with reference to block diagrams of FIG. 7 and FIG. 8 and a flowchart of FIG. 9 is an evacuation instruction process which is performed using the base unit 1 and the handset 2 of the third embodiment of the present invention at the time of receiving an earthquake early warning.

FIG. 9 shows a flow of processing of the base unit 1 of the present embodiment. The processing flow shown in FIG. 9 starts when the power of the base unit 1 is turned on and the base unit 1 has entered a state of performing a phone call process via the PSTN network 63 or the like. After the processing has started, the earthquake information calculation section 11a determines at step S310 whether the reception of an earthquake early warning via a communication network such as the LAN 41 has been detected. In a case where the reception of an earthquake early warning has not been detected, the processing returns to step S310, and the monitoring continues. Although not shown, if the phone call process has ended during the monitoring, the processing ends.

If an earthquake early warning has been detected, then at step S320, the preparation period determination section 11h calculates the preparation period T which exists before the arrival of the earthquake. Further, at step S330, the preparation period determination section 11h compares the preparation period T with the threshold Ta. Based on the comparison result, the processing branches at step S340.

If T>Ta, that is, the preparation period is greater than the threshold, showing relatively low urgency, then the disconnection processing section 11f provides, at step S345, a message to both of the parties to the phone call, that is, the user of the base unit 1 and the other party, the message indicating that the earthquake early warning has been received and the telephone line is to be disconnected. This is performed, for example, by reading a fixed message that is prestored in the flash memory 31, converting the fixed message into sound signals by means of the sound signal processing section 17, and providing the sound signals to the loudspeaker 18 and the communication control section 15.

Note that, if the phone call is being performed not by the base unit 1 but by the handset 2 at step S345, the disconnection processing section 11f communicates with the disconnection processing section 21a of the handset 2 by using the communication control section 15 and the antenna device 16, and notifies the disconnection processing section 21a of T>Ta. Upon receiving the notification, the disconnection processing section 21a reads a fixed message prestored in the flash memory 32, converts the fixed message into sound signals by means of the sound signal processing section 27, and outputs the sound signals from the loudspeaker 28. In this manner, the message indicating the telephone line disconnection can be provided to the user of the handset 2.

Next, at step S350, the disconnection processing section 11f or the disconnection processing section 21a forcibly disconnects the telephone line. Note that, at step S340, if the determination result is not T>Ta, that is, the preparation period is greater than the threshold, indicating high urgency, then the processing immediately shifts to step S350.

Next, at step S360, the control section 11 starts the announcement process of the earthquake early warning. Since the announcement process performed here is the same as that of a conventional technique, the detailed description thereof is omitted herein. Next, at step S370, the earthquake information calculation section 11a determines whether a new earthquake early warning has been detected.

If a new earthquake early warning has not been detected, the processing shifts to step S390 which is described below. If a new earthquake early warning has been detected, then at step S380, information used in the announcement process, which is being performed, is updated with the latest information, that is, the contents of the newly received earthquake early warning, and the announcement is performed, accordingly.

Next, at step S390, the control section 11 determines whether the announcement process is still continuing. Note that, usually, the announcement process continues until a predetermined period, for example, one or two minutes, has elapsed after the expected arrival time of the principal shock. During the predetermined period, a fixed message that is not related to a preparation period, for example, “An earthquake early warning has been received”, is repeatedly outputted.

If it is determined at step S390 that the announcement process is not currently performed, the processing ends. If it is determined at step S390 that the announcement process is still continuing, the control section 11 determines at step S400 whether the communication control section 15 has detected an incoming call. If the communication control section 15 has not detected an incoming call, the processing returns to step S370.

If the communication control section 15 has detected an incoming call, then at step S410, the control section 11 prohibits the communication control section 15, etc., from performing any processes for responding to the incoming call. Accordingly, a response to the incoming call is not performed. In this manner, the base unit 1 enters a state of being unable to participate in a phone call while the earthquake early warning is being announced. This allows the user to be focused on evacuation. Thereafter, the processing returns to step S370.

According to the present embodiment described above, in a case where an earthquake early warning is received during a phone call and a preparation period before the arrival of the earthquake is relatively long, the telephone line is not forcibly disconnected immediately. In this case, a notification that the earthquake early warning has been issued can be provided to both of the parties to the phone call while the telephone line is kept connected. This prevents a situation where the other party becomes confused since the other party cannot know the reason for a disconnection and performs unnecessary operations, for example, repeatedly attempting to re-establish a connection. In a case where the preparation period is short, the announcement of the earthquake early warning is prioritized. Therefore, safety is not compromised.

Next, a fourth embodiment of the present invention is described with reference to the drawings.

### Fourth Embodiment

<4-1. Configuration of Telephone System>

Since the configuration of the telephone system of the fourth embodiment is the same as that described in the first embodiment, the description thereof is omitted herein.

<4-2. Internal Configuration of Base Unit>

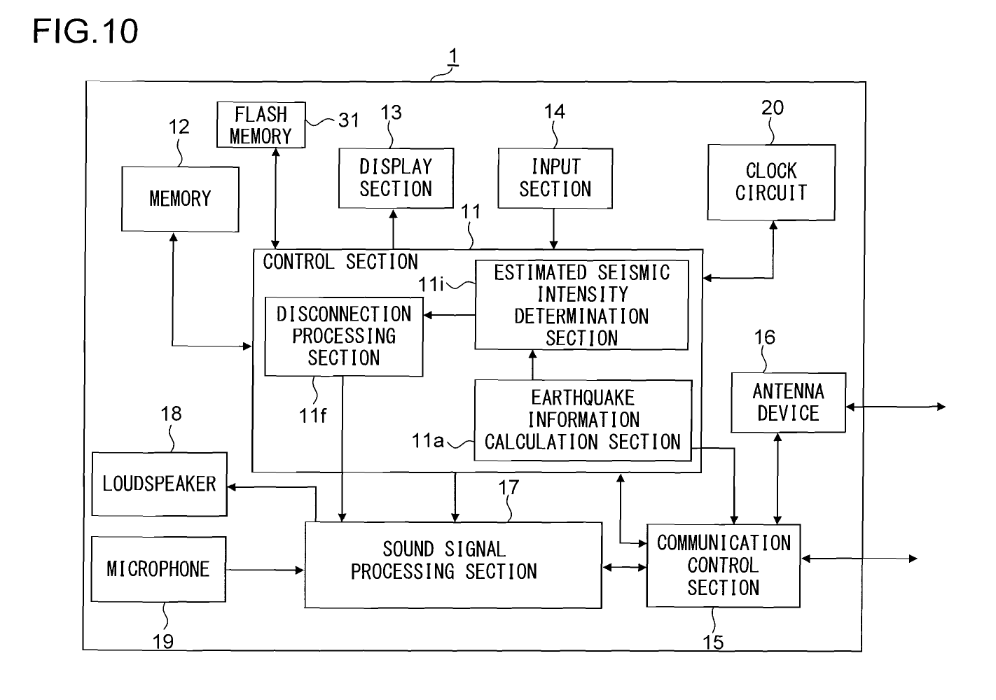

As shown in FIG. 10, in the base unit 1 of the present embodiment, the control section 11 includes an estimated seismic intensity determination section 11i (=a seismic intensity determination section) in place of the preparation period determination section 11h of the third embodiment. Moreover, the function of the disconnection processing section 11f is partially different from that described in the third embodiment.

The estimated seismic intensity determination section 11i determines whether a value indicating an estimated seismic intensity calculated by the earthquake information calculation section 11a (hereinafter, referred to as an “estimated seismic intensity G”) exceeds a predetermined threshold (hereinafter, referred to as a “threshold Ga”). The determination result is provided to the disconnection processing section 11f and the disconnection processing section 21a.

Note that a value indicating the threshold Ga used by the estimated seismic intensity determination section 11i is, for example, stored in a storage medium such as the memory 12 as factory setting. Alternatively, the user may be allowed to set the value by means of a setting screen or the like. The user is allowed to do so if, for example, the control section 11 includes a threshold setting section (not shown) as a functional block that is implemented when the control section 11 executes a predetermined program. In this case, however, in order to ensure safety, it is desired that the upper or lower limit of the threshold Ga is set.

For example, the threshold setting section displays a setting screen for the threshold Ga by means of the display section 13, and waits for an input of a threshold to be performed via the setting screen. Then, the threshold setting section determines whether or not the value of the inputted threshold Ga is within a predetermined range. If the value is within the predetermined range, the inputted threshold Ga is then stored in the flash memory 31. In a case where the value is out of the range, the threshold setting section rejects the setting and outputs an error message, for example.

In a case where the determination result provided by the preparation period determination section 11h indicates G<Ga, the disconnection processing section 11f of the present embodiment instructs the sound signal processing section 17 to perform a notification by sound that notifies the user of the base unit 1 and the other party that an earthquake early warning has been issued and a telephone line currently connected is to be disconnected.

<4-3. Internal Configuration of Handset>

In the present embodiment, the function of the disconnection processing section 21a of the handset 2 is partially different from that described in the third embodiment. In a case where the determination result provided by the preparation period determination section 11h via the communication control section 25 indicates G<Ga, the disconnection processing section 21a of the present embodiment instructs the sound signal processing section 27 to generate a notification sound notifying the user of the handset 2 that an earthquake early warning has been issued and a telephone line currently connected is to be disconnected.

<4-4. Evacuation Instruction Process>

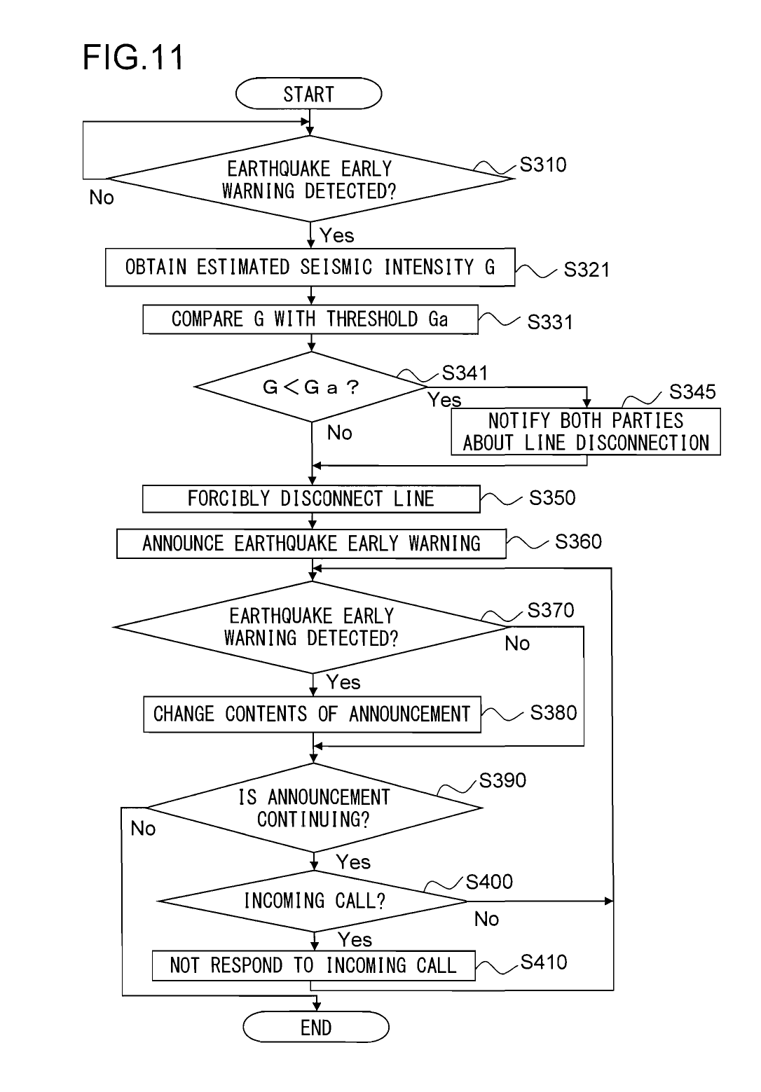

Described hereinafter with reference to a block diagram of FIG. 10 and a flowchart of FIG. 11 is an evacuation instruction process which is performed using the base unit 1 and the handset 2 of the second embodiment of the present invention at the time of receiving an earthquake early warning. Note that the same process steps as those of the third embodiment are denoted by the same step numbers as those used in the third embodiment, and the descriptions thereof are omitted.

If the earthquake information calculation section 11a detects an earthquake early warning at step S310 shown in FIG. 11, then at step S321, the estimated seismic intensity determination section 11i obtains the estimated seismic intensity G from earthquake information calculated by the earthquake information calculation section 11a. Further, at step S331, the estimated seismic intensity determination section 11i compares the estimated seismic intensity G with the threshold Ga. Based on the comparison result, the processing branches at step S341.

If G<Ga, that is, the estimated seismic intensity is less than the threshold, showing a relatively low degree of danger, then the disconnection processing section 11f provides at step S345 a message to both of the parties to the phone call, that is, the user of the base unit 1 or handset 2 and the other party, the message indicating that the earthquake early warning has been received and the telephone line is to be disconnected. Since step S345 is the same as in the third embodiment, the detailed description thereof is omitted herein.

If determination at step S341 does not indicate G<Ga, that is, the estimated seismic intensity is greater than the threshold, showing a high degree of danger, then the processing immediately shifts to step S350. Since the processing at step S350 and thereafter is the same as in the third embodiment, the description thereof is omitted.

According the present embodiment described above, in a case where an earthquake early warning is received during a phone call and the estimated seismic intensity is relatively small, the telephone line is not forcibly disconnected immediately. In this case, a notification that the earthquake early warning has been issued can be provided to both of the parties to the phone call while the telephone line is kept connected. This prevents a situation where the other party becomes confused since the other party cannot know the reason for a disconnection and performs unnecessary operations, for example, repeatedly attempting to re-establish a connection. In a case where the estimated seismic intensity is great, the announcement of the earthquake early warning is prioritized. Therefore, safety is not compromised.

Next, a fifth embodiment of the present invention is described with reference to the drawings.

### Fifth Embodiment

### <5-1. Configuration of Telephone System>

Since the configuration of the telephone system of the fifth embodiment is the same as that described in the first embodiment, the description thereof is omitted herein.

### <5-2. Internal Configuration of Base Unit>

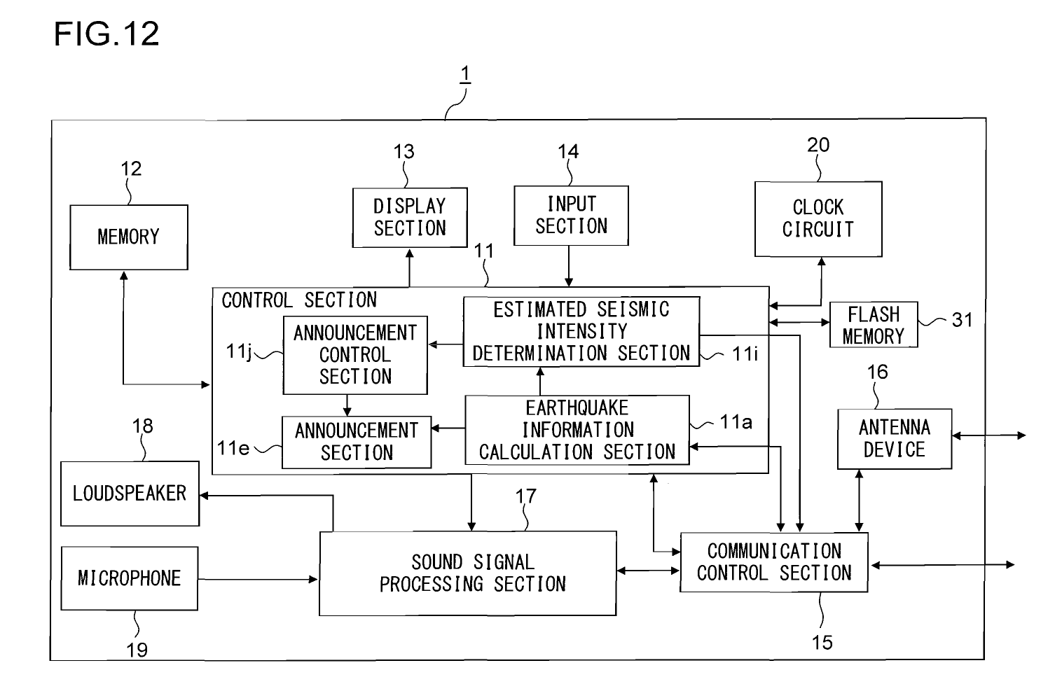

As shown in FIG. 12, the base unit 1 of the present embodiment includes an announcement control section 11j in addition to the above-described earthquake information calculation section 11a, announcement section 11e, and estimated seismic intensity determination section 11i.

In a case where a comparison result provided by the estimated seismic intensity determination section 11i indicates G<Ga, the announcement control section 11j prohibits the announcement section 11e from performing the announcement process and the process of ceasing predetermined functions. That is, the base unit 1 is prohibited from entering the function ceased state. Note that if the function ceased state is already entered, the function ceased state is cancelled. Accordingly, for example, in a case where the user is participating in a phone call at the time of receiving an earthquake early warning, the phone call process is not disrupted by the announcement section 11e. Therefore, the user can continue the phone call.

### <5-3. Internal Configuration of Handset>

Since the internal configuration of the handset of the fifth embodiment is the same as that described in the first embodiment, the description thereof is omitted herein.

### <5-4. Announcement Control Process>

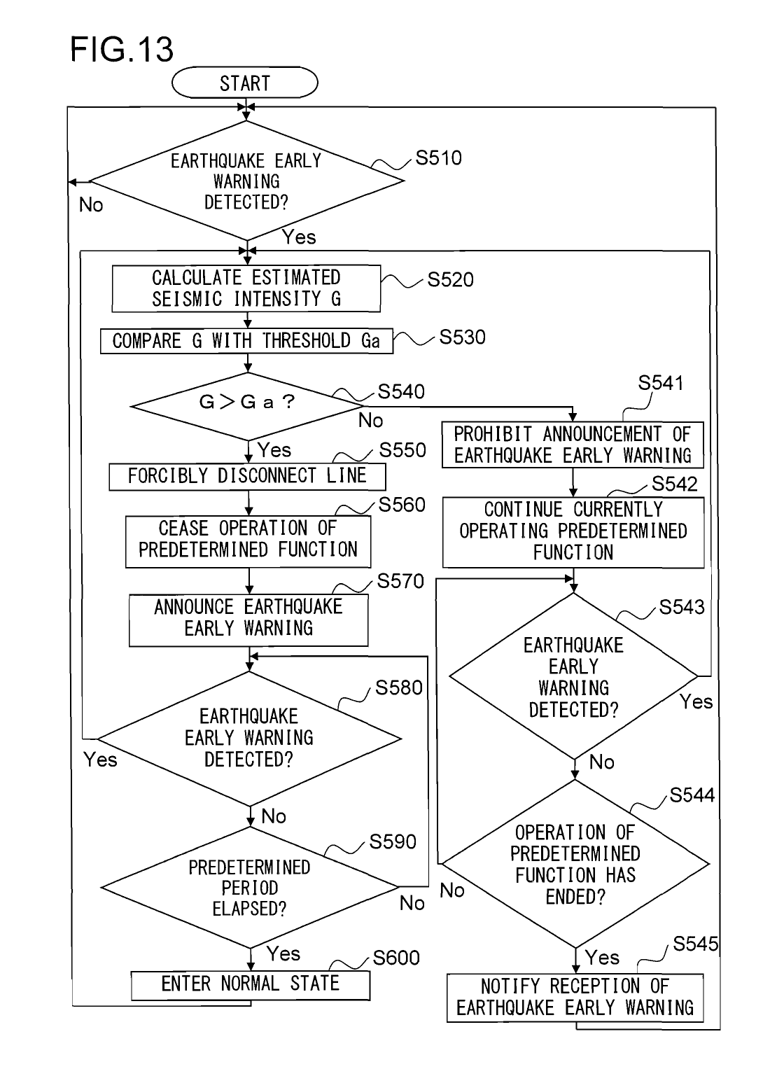

Hereinafter, an announcement control process of the fifth embodiment of the present invention will be described with reference to a block diagram of FIG. 12 and a flowchart of FIG. 13.

FIG. 13 shows a flow of processing of the base unit 1 of the present embodiment. The processing flow shown in FIG. 13 starts when the power of the base unit 1 is turned on and the base unit 1 has become able to receive an earthquake early warning via the wired LAN 41 or the like. After the processing has started, the earthquake information calculation section 11a determines at step S510 whether or not the reception of an earthquake early warning has been detected. If the reception of an earthquake early warning has not been detected, the processing returns to step S510 and the monitoring continues.

If an earthquake early warning has been detected, then at step S520, the earthquake information calculation section 11a calculates the estimated seismic intensity the expected arrival time of the principal shock, etc., for the area where the base unit 1 is installed, based on information contained in the received earthquake early warning and information preset in the base unit 1, for example, regional information.

Next, at step S520, the estimated seismic intensity determination section 11i compares the estimated seismic intensity G with the threshold Ga which is prestored in the flash memory 31. Based on the comparison result, the processing branches at step S540.

If G>Ga, that is, the estimated seismic intensity is greater than the threshold, showing a relatively high degree of danger, then the announcement section 11e forcibly disconnects the telephone line at step S550. Note that if the telephone line is not in a state of connection, it is not necessary to perform the disconnection process.

Next, at step S560, the announcement section 11e ceases operations of predetermined functions among currently operating functions, thereby causing the base unit 1 and the handset 2 to enter the function ceased state. As a result, for example, a phone call process, an e-mail creation process, a facsimile transmission process, and the like that are being performed are forcibly interrupted.

Subsequently, at step S570, the announcement section 11e starts the announcement process of the earthquake early warning. Since the announcement process performed here is the same as that of a conventional technique, the detailed description thereof is omitted herein. Next, at step S580, the earthquake information calculation section 11a determines whether or not a new earthquake early warning has been detected.

If a new earthquake early warning has been detected, the processing returns to step S520, and the estimated seismic intensity G is calculated based on the new earthquake early warning. If a new earthquake early warning has not been detected, then at step S590, the announcement section 11e determines whether or not a predetermined period has elapsed after the start of earthquake early warning announcement.

If the predetermined period has not elapsed, the processing returns to step S580. If the predetermined period has elapsed, then at step S600, the announcement section 11e ends the announcement process to cause the base unit 1 and the handset 2 to enter a normal state. As a result, the operations of the predetermined functions, which have been ceased, are enabled. When step S600 ends, the processing returns to step S510.

Now, the description returns to step S540. If the determination at step S540 is G<Ga, that is, the estimated seismic intensity is less than the threshold, showing a relatively low degree of danger, then the processing shifts to step S541. At step S541, the announcement control section 11j prohibits the announcement section 11e from performing the announcement process of the earthquake early warning. Then, at step S542, operations of the predetermined functions among the currently operating functions continue. Note that if the function ceased state is already entered, the function ceased state is cancelled. Accordingly, for example, even during the predetermined period after the reception of the earthquake early warning, a phone call process and the like can be performed.

Next, the announcement control section 11j determines at step S543 whether the earthquake information calculation section 11a has received a new earthquake early warning. If the earthquake information calculation section 11a has received a new earthquake early warning, the processing shifts to step S520. If the earthquake information calculation section 11a has not received a new earthquake early warning, then at step S544, the announcement control section 11j determines whether or not the previously continued operations of the predetermined functions have been completed. For example, the operations are determined to have been completed in a case where the telephone line has been disconnected when a phone call is ended or when an e-mail has been created and transmitted.

If the operations of the predetermined functions have not been completed, the processing shifts to step S543. If the operations of the predetermined functions have been completed, then at step S545, the announcement control section 11j provides a notification that an earthquake early warning has been received during the operations of the predetermined functions. For example, the notification is provided in such a manner that character images are displayed on the display section 13 for the notification and a notification sound is generated and outputted by using the sound signal processing section 17 and the loudspeaker 18. When the notification has been completed, the processing returns to step S510.

Note that the processing described above can be ended at any timing if, for example, the power of the base unit 1 is turned off or communication malfunction of the communication control section 15 has occurred.

According to the present embodiment as described above, in a case where the estimated seismic intensity is relatively small and the necessity of performing the announcement is estimated to be low, the announcement process is not performed and the operations of predetermined functions are not ceased. As a result, operations that the user is performing are not disrupted by an announcement of low importance. This improves convenience. If the estimated seismic intensity exceeds the threshold, the announcement is performed. Therefore, safety is not compromised.

Further, according to the present embodiment as described above, in a case where the announcement is not performed due to a relatively low estimated seismic intensity, a notification that an earthquake early warning has been received is provided after the operations of predetermined functions have been completed. This allows the user to know, after the operations of the predetermined functions have been completed, minimum information regarding the reception of the earthquake early warning.

Next, a sixth embodiment of the present invention is described with reference to the drawings. The present embodiment shows a case where the handset 2 performs the announcement control process described in the fifth embodiment.

### Sixth Embodiment

<6-1. Configuration of Telephone System>

Since the configuration of the telephone system of the sixth embodiment is the same as that described in the first embodiment, the description thereof is omitted herein.

<6-2. Internal Configuration of Base Unit>

Although the components of the base unit 1 of the sixth embodiment are the same as those of the fifth embodiment, the function of the earthquake information calculation section 11a is partially different from that described in the fifth embodiment. The earthquake information calculation section 11a of the present embodiment transmits calculated earthquake information to the control section 21 of the handset 2 by means of the communication control section 15.

<6-3. Internal Configuration of Handset>

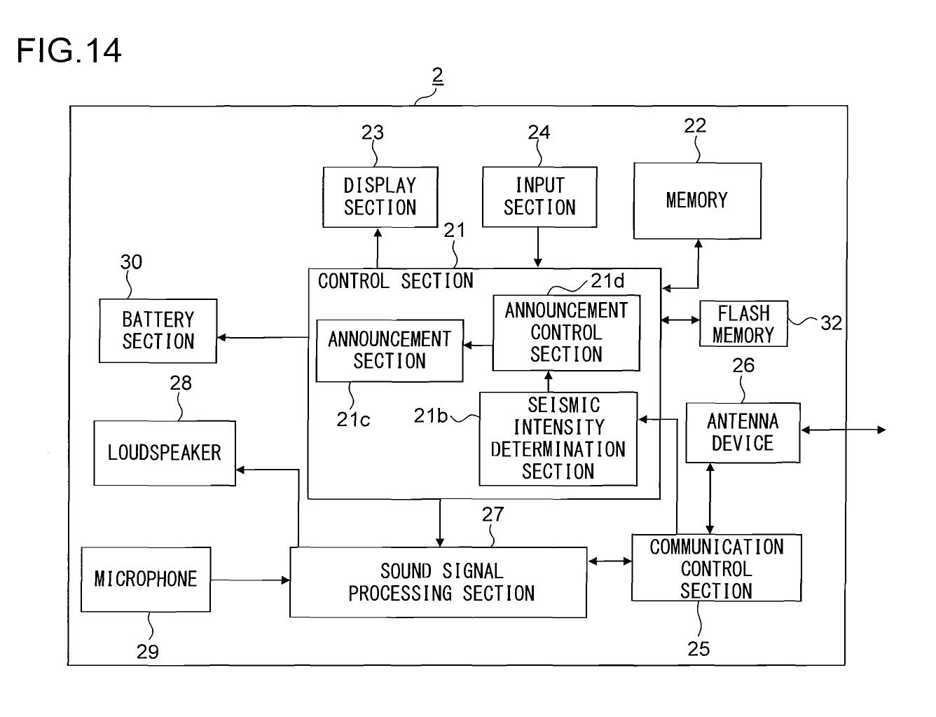

As shown in FIG. 14, the handset 2 of the present embodiment includes a seismic intensity determination section 21b, an announcement section 21c, and an announcement control section 21d as functional blocks that are implemented when a program is executed by the arithmetic processing unit of the control section 21. Further, the handset 2 of the present embodiment includes the flash memory 32 as a storage medium for storing the threshold Ga.

The seismic intensity determination section 21b performs comparison to determine whether or not the estimated seismic intensity G that is contained in the earthquake information received from the base unit 1 exceeds the predetermined threshold Ga. Note that the threshold Ga used here is read from the flash memory 32. The comparison result is provided to the announcement control section 21d.

The announcement section 21c receives, by means of the communication control section 25, the earthquake information which has been calculated by the earthquake information calculation section 11a of the base unit 1. Based on the earthquake information, the announcement section 21c performs an announcement regarding the earthquake. Also, the announcement section 21c causes the handset 2 to enter the function ceased state for a predetermined period for the purpose of prioritizing the announcement process. Since the announcement process performed here is the same as that performed by the announcement section 11e of the base unit 1, the detailed description thereof is omitted.

If the comparison result provided by the seismic intensity determination section 21b indicates G<Ga, the announcement control section 21d prohibits the announcement section 21c from performing the announcement process and the process of ceasing predetermined functions. That is, a shift to the function ceased state is prohibited. Note that if the function ceased state is already entered, the function ceased state is cancelled. Accordingly, for example, in a case where the user is participating in a phone call by means of the handset 2 at the time of receiving an earthquake early warning, the phone call process is not disrupted by the announcement section 21c. Therefore, the user can continue the phone call.

<6-4. Announcement Control Process>

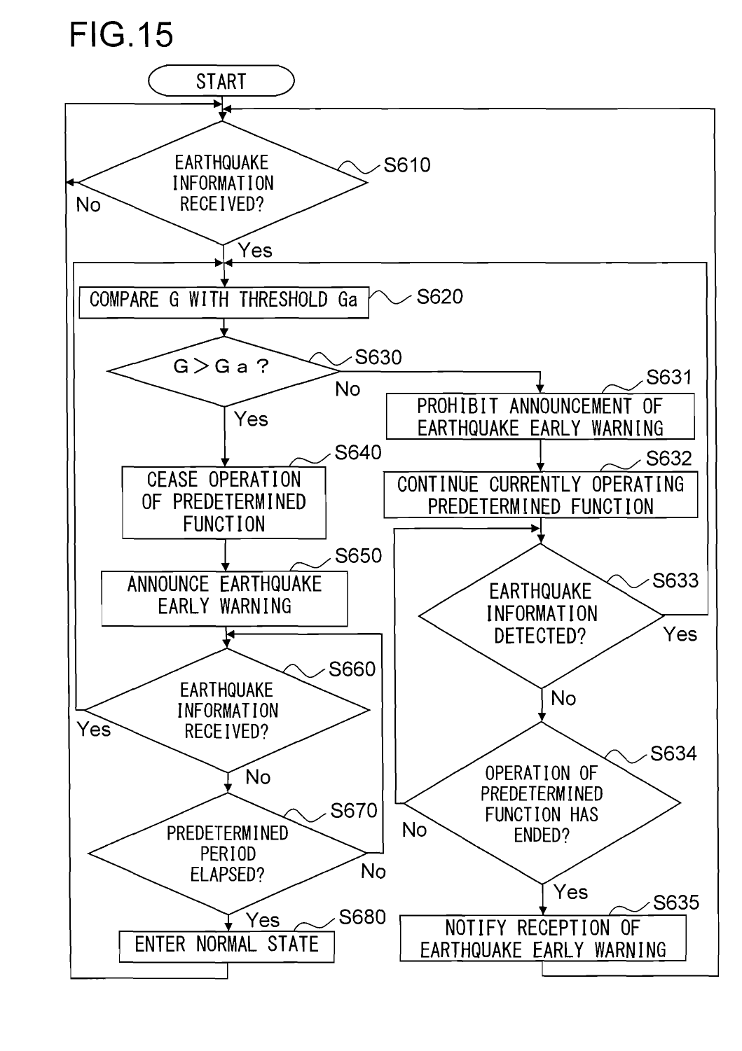

Hereinafter, the announcement control process according to the sixth embodiment of the present invention will be described with reference to a block diagram of FIG. 14 and a flowchart of FIG. 15.

FIG. 15 shows a flow of processing of the handset 2 of the present embodiment. The processing flow shown in FIG. 15 starts when the power of the base unit 1 and the power of the handset 2 are turned on and the base unit 1 and the handset 2 have become able to communicate with each other via the wireless LAN 42. After the processing has started, the seismic intensity determination section 21b determines at step S610 whether or not earthquake information has been received from the base unit 1. If earthquake information has not been received, the processing returns to step S610 and the monitoring continues.

If earthquake information has been received, then at step S620, the seismic intensity determination section 21b compares the estimated seismic intensity G with the threshold Ga which is prestored in the flash memory 32. Based on the comparison result, the processing branches at step S630.

If G>Ga, that is, the estimated seismic intensity is greater than the threshold, showing a relatively high degree of danger, then at step S640, the announcement section 21c ceases operations of predetermined functions among currently operating functions, thereby causing the handset 2 to enter the function ceased state.

Next, at step S650, the announcement section 21c starts the announcement process of an earthquake early warning. Since the announcement process performed here is the same as that of a conventional technique, the detailed description thereof is omitted herein. Next, at step S660, the seismic intensity determination section 21b determines whether or not new earthquake information has been received from the base unit 1.

If new earthquake information has been received, the processing returns to step S620, and the estimated seismic intensity G that is contained in the new earthquake information is compared with the threshold Ga. If new earthquake information has not been received, then at step S670, the announcement section 21c determines whether or not a predetermined period has elapsed after the reception of earthquake information has been detected.

If the predetermined period has not elapsed, the processing returns to step S660. If the predetermined period has elapsed, then at step S680, the announcement section 21c ends the announcement process to cause the handset 2 to enter a normal state. As a result, the operations of the predetermined functions, which have been ceased, are enabled. When step S680 ends, the processing returns to step S610.

Now, the description returns to step S630. If determination at step S630 is G<Ga, that is, if the estimated seismic intensity is less than the threshold, showing a relatively low degree of danger, then the processing shifts to step S631. At step S631, the announcement control section 21d prohibits the announcement section 21c from performing the announcement process of the earthquake early warning. Then, at step S632, operations of the predetermined functions among the currently operating functions continue. Here, if the function ceased state is already entered, the function ceased state is cancelled.

Next, at step S633, the announcement control section 21d determines whether or not the seismic intensity determination section 21b has received new earthquake information from the base unit 1. If the seismic intensity determination section 21b has received new earthquake information from the base unit 1, the processing shifts to step S620. If the seismic intensity determination section 21b has not received new earthquake information from the base unit 1, the announcement control section 21d determines at step S634 whether or not the previously continued operations of the predetermined functions have been completed.

If the operations of the predetermined functions have not been completed, the processing shifts to step S633. If the operations of the predetermined functions have been completed, then at step S635, the announcement control section 21d provides a notification that an earthquake early warning has been received during the operations of the predetermined functions. When the notification has been completed, the processing returns to step S610.

Note that the processing described above can be ended at any timing if, for example, the power of the handset 2 is turned off or communication malfunction has occurred between the communication control section 25 and the base unit 1.

According to the present embodiment described above, the announcement control process of the present invention is performed not by the base unit 1 but by individual handsets 2. Accordingly, the announcement control process can be performed only by a specific handset 2. Moreover, even if the base unit 1 to which the handsets 2 are connected is changed, the announcement control process can be performed in the same manner after such a change since the handsets 2 each include functional blocks for performing the announcement control process of the present invention. Furthermore, since the threshold Ga can be separately set for each handset 2, the handset 2 that prioritizes the announcement process or the handset 2 that does not prioritize the announcement process can be separately used in accordance with the situation.

### Other Embodiments

The foregoing description has described the preferred embodiments and examples of the present invention. However, the present invention is not necessarily limited to the above-described embodiments but may be implemented with various modifications being made within the scope of the technical idea of the present invention.

Accordingly, the present invention is also applicable to other embodiments described below.

(A) Although in the above embodiments the wired LAN 41 and the Internet 62 are used as the communication lines for the base unit 1 to receive an earthquake early warning, an earthquake early warning may be received from any other communication networks, such as a dedicated line and a cable television line. Moreover, an earthquake early warning may be obtained from airwaves such as those used for digital terrestrial broadcasting and BS digital broadcasting.

(B) The above embodiments describe, as examples, configurations in which the base unit 1 includes the functional blocks involved in the evacuation instruction process. However, part of the functional blocks may be realized by, for example, each handset 2 or an external device that is connected via a network. For example, the address book referred to by the disconnection reason notification section 11c, the sound information used by the disconnection processing section 11f, the threshold Ga used by the estimated seismic intensity determination section 11i, and the like may be stored not in the flash memory 31 but in an information processing apparatus (e.g., a network server) that is present on a network. In such a case, if it is desired that the contents of the above information be changed, the information, which is referred to by a plurality of communication devices, can be changed at one time. This eliminates the necessity of changing the setting for each communication device separately.

(C) The above embodiments describe cordless telephone devices including the base unit 1 and the handsets 2, as examples of communication devices that have the earthquake early warning notification function of the present invention. However, the present invention may be implemented in any other devices so long as they serve as communication devices capable of connecting to a wide area communication network and receiving an earthquake early warning. For example, the present invention may be implemented in mobile phones with wireless LAN connection capability, Internet phones, IP phones that include a handset with IP communication capability, applications to be executed by a personal computer that has a phone call function, or the like.

(D) In the above embodiments, various functional blocks of the base unit 1, which are involved in the notification process of the present invention, are realized by executing a program on an arithmetic processing unit such as a microprocessor. However, these various functional blocks may be realized by a plurality of circuits.

(E) In the above embodiments, in a case where a telephone line is forcibly disconnected due to the reception of an earthquake early warning, the forcible disconnection is notified by an e-mail or a sound message. However, such notification may be provided only in a case where a telephone line is forcibly disconnected and then a reconnection is requested by the other party previously participating in the phone call. In this manner, unnecessary processing can be reduced in a case where the other party does not request a reconnection, that is, a case where there is no urgency.

(F) The above embodiments do not particularly specify the length of a period in which incoming calls are rejected after the reception of an earthquake early warning; the length of a period in which an announcement is performed after the earthquake early warning countdown has been completed; and the length of a period in which the function ceased state is maintained after the reception of an earthquake early warning. However, the user may set in advance the length of each of these periods to 30 seconds, one minute, or two minutes, for example. Alternatively, the lengths of these periods may be set to fixed values as factory settings which the user cannot change.

(G) In the above embodiments, the disconnection reason notification section 11c performs a notification by an e-mail, and the rejection reason notification section 11g performs a notification by a sound message. However, conversely, the disconnection reason notification section 11c may perform a notification by a sound message, and the rejection reason notification section 11g may perform a notification by an e-mail. As a further alternative, each of these functional blocks may perform both a notification by an e-mail and a notification by a sound message.

(H) The above embodiments describe examples in which both the base unit 1 and the handset 2 include a disconnection processing section. However, only the base unit 1 may include a disconnection processing section. In this case, if the base unit 1 receives an earthquake early warning while the handset 2 is in use on an external phone call, then the disconnection processing section 11f of the base unit 1 transmits a notification sound to the handset 2 via the communication control section 15, and disconnects the telephone line after the notification sound has been outputted from the loudspeaker 28. Performing all the processing at the base unit 1 side in this manner makes it possible to reduce the number of components of the handset 2.

(I) The above embodiments describe the handsets 2 each having wireless communication functions as an example of handsets that are included among the communication devices of the present invention. However, handsets without wireless communication functions that are only capable of wired communication may be used instead.

(J) In the above embodiments, an estimated preparation period before the arrival of an earthquake, or an estimated seismic intensity, is used as a reference for determining whether the importance of an earthquake early warning is high or low. However, the determination may be performed using both the estimated preparation period and the estimated seismic intensity. For example, only in a case where the estimated preparation period is 10 seconds or longer and the estimated seismic intensity is 3 or less, a telephone line may be disconnected after a notification for the disconnection is given.

(K) In the above embodiments, in a case where the preparation period is equal to or longer than the threshold, a notification is provided in the form of a fixed message to a user performing communication and the other party. However, in place of such a fixed message, a normal sound message of an earthquake early warning may be used. In such a case, if the preparation period is equal to or longer than the threshold, forcible disconnection of a telephone line is not performed and an earthquake early warning countdown sound superimposed on a telephone voice is provided to the user and the other party while the connection of the telephone line is maintained. This allows both the parties to recognize that the earthquake early warning has been issued.

(L) In the above embodiments, in a case where the estimated seismic intensity is less than the threshold, the announcement is not performed and the shift to the function ceased state is prohibited. However, as an alternative, in a case where the estimated seismic intensity is less than the threshold, the announcement may be performed while the shift to the function ceased state is prohibited. This allows the announcement process and the predetermined functions to be performed in parallel. However, in this case, if the announcement is performed by sound, the announcement interferes with the phone call function and the like. Therefore, it is desired that the announcement is performed by merely using an image or lighting of a lamp (not shown).

(M) In relation to the above, the announcement manner may be changed as necessary in accordance with currently operating functions. For example, the announcement is performed by an image if a voice call is being performed, and the announcement is performed by sound if e-mail creation is being performed. This makes it possible to perform the announcement in a manner less likely to interfere with operations of respective functions.

(N) The above embodiments give descriptions where the phone call function, the e-mail transmission/reception function, and the facsimile transmission/reception function are taken as examples of the functions, the operations of which are ceased when an earthquake early warning has been received. However, operations of other functions may be additionally ceased when an earthquake early warning has been received.

1. A communication device comprising:
a communication section operable to connect to a communication network;
an earthquake information calculation section for receiving an earthquake early warning from the communication network by means of the communication section to calculate earthquake information;
a disconnection processing section for disconnecting a telephone line if the earthquake early warning has been received while the telephone line is connected by means of the communication section; and
a disconnection reason notification section for transmitting disconnection reason information, which indicates a disconnection reason, to a communication counterpart on the telephone line that has been disconnected when the earthquake early warning has been received.

2. The communication device according to claim 1, comprising:
a mail transmission section for transmitting an e-mail by means of the communication section; and
a storage section for storing association information in which a telephone number and an e-mail address are associated with each other, wherein
the disconnection reason notification section determines, based on the association information, an e-mail address that is associated with a telephone number of the communication counterpart, and controls the mail transmission section to transmit an e-mail that contains the disconnection reason information to the determined e-mail address.

3. The communication device according to claim 2, comprising a number determination section for determining based on numbers contained in the telephone number whether or not the telephone number is a mobile phone number, wherein
if the number determination section has determined that the telephone number of the communication counterpart is a mobile phone number, the disconnection reason notification section determines, based on the association information, the e-mail address that is associated with the telephone number of the communication counterpart, and controls the mail transmission section to transmit an e-mail that contains the disconnection reason information to the determined e-mail address.

4. The communication device according to claim 2, wherein the disconnection reason notification section determines based on the association information whether or not the e-mail address that is associated with the telephone number of the communication counterpart is a mobile phone e-mail address, and if determining that the e-mail address is a mobile phone e-mail address, controls the mail transmission section to transmit an e-mail that contains the disconnection reason information to the e-mail address.

5. The communication device according to claim 1, comprising a rejection reason notification section for rejecting, if the communication section detects a request for connection of a telephone line within a predetermined period after the earthquake information calculation section has received the earthquake early warning, the request for the connection, and for transmitting rejection reason information, which indicates a rejection reason, to the source of the request for the connection.

6. The communication device according to claim 5, comprising:
a mail transmission section for transmitting an e-mail by means of the communication section; and
a storage section for storing association information in which a telephone number and an e-mail address are associated with each other, wherein
the rejection reason notification section determines, based on the association information, an e-mail address that is associated with a telephone number of the source, and controls the mail transmission section to transmit an e-mail that contains the rejection reason information to the determined e-mail address.

7. The communication device according to claim 6, comprising a number determination section for determining based on numbers contained in the telephone number whether or not the telephone number is a mobile phone number, wherein
if the number determination section has determined that the telephone number of the source is a mobile phone number, the rejection reason notification section determines, based on the association information, the e-mail address that is associated with the telephone number of the source, and controls the mail transmission section to transmit an e-mail that contains the rejection reason information to the determined e-mail address.

8. The communication device according to claim 7, wherein the rejection reason notification section determines based on the association information whether or not the e-mail address that is associated with the telephone number of the source is a mobile phone e-mail address, and if determining that the e-mail address is a mobile phone e-mail address, controls the mail transmission section to transmit an e-mail that contains the rejection reason information to the e-mail address.

9. The communication device according to claim 1, comprising:
a timer section for keeping time;
a sound processing section for performing a process of decoding sound information;
a loudspeaker for outputting a sound; and
a period determination section for calculating, if the earthquake early warning has been received while the telephone line is connected by means of the communication section, an estimated period before arrival of an earthquake by means of the earthquake information calculation section and the timer section, and for determining whether or not the estimated period exceeds a predetermined threshold, wherein
when the period determination section determines that the estimated period exceeds the threshold, the disconnection processing section performs the following: instruct the sound processing section to generate a notification sound notifying that the earthquake early warning has been received or that the telephone line is to be disconnected; transmit the generated notification sound to the telephone line by means of the communication section and output the generated notification sound by means of the loudspeaker; and control the communication section to disconnect the telephone line.

10. The communication device according to claim 9, comprising a seismic intensity determination section for determining, if the earthquake early warning has been received while the telephone line is connected by means of the communication section, whether or not an estimated seismic intensity contained in the earthquake information calculated by the earthquake information calculation section exceeds a predetermined threshold, wherein
when the seismic intensity determination section has determined that the estimated seismic intensity is less than the threshold, the disconnection processing section performs the following: instruct the sound processing section to generate a notification sound notifying that the earthquake early warning has been received or that the telephone line is to be disconnected; transmit the generated notification sound to the telephone line by means of the communication section and output the generated notification sound by means of the loudspeaker; and control the communication section to disconnect the telephone line.

11. The communication device according to claim 10, comprising:
a main communication device which includes the communication section, the earthquake information calculation section, the timer section, the sound processing section, the loudspeaker, the period determination section, the seismic intensity determination section, and the disconnection processing section; and
a subordinate communication device which includes a second communication section operable to communicate with the main communication device, the disconnection processing section, the sound processing section, and the loudspeaker, wherein
if the main communication device has determined, by means of the period determination section, that the estimated period exceeds the threshold, or if the main communication device has determined, by means of the seismic intensity determination section, that the estimated seismic intensity is less than the threshold, then the main communication device provides the disconnection processing section of the subordinate communication device with a notification that the estimated period exceeds the threshold or that the estimated seismic intensity is less than the threshold, and
upon receiving the notification, the disconnection processing section of the subordinate communication device performs the following: instruct the sound processing section to generate the notification sound; transmit the generated notification sound to the telephone line by means of the second communication section and output the generated notification sound by means of the loudspeaker; and control the communication section to disconnect the telephone line.

12. A communication device comprising:
a first communication section operable to connect to a communication network;
an earthquake information calculation section for calculating earthquake information based on an earthquake early warning which the earthquake information calculation section receives from the communication network by means of the first communication section;
a seismic intensity determination section for determining whether or not an estimated seismic intensity contained in the earthquake information exceeds a threshold;
an announcement section for performing an announcement process based on the earthquake information, and performing a function ceasing process of ceasing a predetermined function among functions of the communication device during a predetermined period after the earthquake information calculation section has received the earthquake early warning; and
an announcement control section for prohibiting the announcement section from performing the announcement process and the function ceasing process if the earthquake information calculation section has received the earthquake early warning and the seismic intensity determination section has determined that the estimated seismic intensity is less than the threshold which is predetermined.

13. The communication device according to claim 12, wherein the announcement control section performs, if the earthquake information calculation section has received the earthquake early warning while the predetermined function is operating and the seismic intensity determination section has determined that the estimated seismic intensity is less than the threshold, a reception notification when the function has ended operating, the reception notification indicating that the earthquake early warning has been received.

14. The communication device according to claim 12, comprising:
a main communication device which includes the first communication section, the earthquake information calculation section, the seismic intensity determination section, the announcement section, and the announcement control section; and
a subordinate communication device which includes a second communication section operable to communicate with the main communication device, wherein
if the seismic intensity determination section has determined that the estimated seismic intensity is less than the threshold, the announcement control section prohibits the announcement process and the function ceasing process from being performed for the main communication device and the subordinate communication device.

15. The communication device according to claim 14, comprising:
a main communication device which includes the first communication section and the earthquake information calculation section; and
a subordinate communication device which includes a second communication section operable to communicate with the main communication device, the announcement section, the announcement control section, and the seismic intensity determination section, wherein
the main communication device transmits the earthquake information calculated by the earthquake information calculation section to the subordinate communication device by means of the first communication section,
upon receiving the earthquake information by means of the second communication section, the seismic intensity determination section of the subordinate communication device determines whether or not an estimated seismic intensity contained in the earthquake information exceeds the threshold, and
if the seismic intensity determination section has determined that the estimated seismic intensity is less than the threshold, the announcement control section prohibits the announcement section from performing the announcement process and the function ceasing process.
